(19) United States
(12) Patent Application Publication
(10) Pub. No.: US 2018/0250585 A1
(43) Pub. Date: Sep. 6, 2018

(54) SYSTEM, DEVICE AND METHOD OF RUNNING GAME BASED ON SPECTROMETER DATA

(71) Applicant: Verifood, Ltd., Herzliya (IL)

(72) Inventors: Liron Nunez WEISSMAN, Rosh-Haayin (IL); Yaniv BERTELE, Tel-Aviv (IL); Guy SPIRA, Batzra (IL); Guy BRODETZKI, Rehovot (IL); Hagai HESHES, Shimshit (IL)

(21) Appl. No.: 15/858,340

(22) Filed: Dec. 29, 2017

Related U.S. Application Data
(60) Provisional application No. 62/440,697, filed on Dec. 30, 2016.

(51) Int. Cl. A63F 13/213; G01J 3/02; A63F 13/217; A63F 13/90

(52) U.S. Cl. CPC A63F 13/213; G01J 3/0272; A63F 13/90; A63F 13/217; G01J 3/0264

(57) ABSTRACT

A device running a game based on spectrometer data comprises a spectrometer configured to detect the spectrometer data of a real-life object, the spectrometer data indicating one or more features of the real-life object, and one or more processors configured to receive the spectrometer data of a real-life object from a spectrometer, determine a game object based on the spectrometer data, wherein the game object has one or more attributes corresponding to the one or more of features of the real-life object, and perform one or more actions on the game object based on the one or more attributes of the game object. Spectrometer data of real-life objects can be generated to create game objects and modify game attributes of the game objects, which can bring more fun into gaming, and stimulate the game player's interest and curiosity in exploring the characteristic associated with various objects in real world.

### CROSS-REFERENCE

The present application claims priority to U.S. Provisional Patent Application No. 62/440,697, entitled “SYSTEM, DEVICE AND METHOD OF RUNNING GAME BASED ON SPECTROMETER DATA”, filed Dec. 30, 2016, which application is herein incorporated by reference in its entirety for all purposes.

### BACKGROUND OF THE INVENTION

Spectrometers are used for many purposes. For example, spectrometers are used in industrial defect detection, laboratory research and food composition detection. The spectroscopic information of a subject can be used to identify the subject. The spectroscopic information can be utilized in combination with industrial apparatuses and consumer products in various fields.

Although portable high resolution spectrometers have been proposed, spectrometers are not widely used with consumer products. For example, mobile devices equipped with spectrometers for personal entertainment purpose are not available on the market.

A system and method of running video games based on spectrometer data would broaden the application horizon of spectrometers. Real-life object information, such as category and chemical composition of a real-life object as detected by spectrometers, can be used to create or modify game objects in a game. For example, spectrometer data of a real-life object can be mapped to game attributes of a game object, such that the spectrometer data of the real-life object can be used to create a game object and/or change game attributes of the game object. The game player can thus be motivated to explore various real-life objects using spectrometers in playing the game.

### SUMMARY OF THE INVENTION

The present disclosure provides system, device and method of running video games based on spectrometer data. The spectrometer data of real-life objects can be used to create game objects and modify game attributes of the game objects. In playing a game, the user can scan real-life objects with the spectrometer which is integrated with a mobile device, and the spectrometer data such as identification or composition of the scanned real-life objects can be recognized. A game object such as a virtual game character or item can be created or modified based on the spectrometer data.

The game player can create a virtual game character by scanning a real-life object such as piece of freshly cut beef using a spectrometer. A game character corresponding to a characteristic of beef can be created in the game. The game player can then evolve or develop the created game character in many ways by scanning other real-life objects to create virtual items. The game player can attack the created game character in the game with other game characters which can be created by other game players. The introduction of spectrometer data of real-life objects into games can bring more fun in gaming, and stimulate the game player's interest and curiosity in exploring the characteristic (e.g., a chemical composition, a category of a material, a nutrition fact, a total fat, a geographic origin) associated with various objects in real world.

According to some aspects, the present disclosure discloses a method performed by a user device of running a game based on a spectrometer data. The method can comprise receiving, from a spectrometer, the spectrometer data of a real-life object from the spectrometer, the spectrometer data indicating one or more features of the real-life object; determining, by one or more processors, a game object based on the spectrometer data, wherein the game object can have one or more attributes corresponding to the one or more features of the real-life object; and performing one or more actions on the game object based on the one or more attributes of the game object.

The spectrometer data can comprise a spectrum profile. In some embodiments, the real-life object can comprise an organic object. In some instances, the organic object is food. Optionally, the organic object is a plant. Alternatively, the real-life object can comprise an inorganic object. Alternatively, the real-life object can comprise a human being. For instance, the human being can be a game player.

In some embodiments, the one or more features of the real-life object can comprise a composition of the real-life object. Alternatively, the one or more features of the real-life object can comprise a category of the real-life object. Determining the game object can comprise identifying the real-life object based on the spectrometer data. For instance, identifying the real-life object can be based on a predetermined mapping between the real-life object and the spectrometer data. In some embodiments, determining the game object can comprise creating the game object based on the spectrometer data. Alternatively, determining the game object can comprise selecting the game object from existing game objects. Alternatively, determining the game object can comprise sending the spectrometer data to a spectrometer server over a communication network, and receiving information regarding the game object from the spectrometer server, the spectrometer server comprising a database storing and updating spectrometer data associated with real-life objects.

In some embodiments, performing one or more actions on the game object can comprise selecting the one or more actions from among a plurality of existing actions. Alternatively, performing one or more actions on the game object can comprise updating the one or more attributes of the game object. Alternatively, performing one or more actions on the game object comprises displaying the one or more attributes of the game object. Alternatively, performing one or more actions on the game object can comprise updating a cumulative score. Still alternatively, performing one or more actions on the game object can comprise causing at least one interaction between the game object and one or more other game objects based on the one or more attributes. For instance, the method can comprise updating a score based on the at least one interaction. The score can be updated by comparing the one or more attributes of the game object with corresponding one or more attributes of the one or more other game objects.

According to some aspects, the present disclosure discloses a device for running a game based on spectrometer data. The device can comprise a spectrometer configured to detect the spectrometer data of a real-life object, the spectrometer data indicating one or more features of the real-life object; and one or more processors, individually or collectively configured to receive the spectrometer data of a real-life object from a spectrometer; determine a game object based on the spectrometer data, wherein the game object can have one or more attributes corresponding to the one or more of features of the real-life object; and perform one or more actions on the game object based on the one or more attributes of the game object.

The spectrometer data can comprise a spectrum profile. In some embodiments, the real-life object can comprise an organic object. In some instances, the organic object is food. Optionally, the organic object is a plant. Alternatively, the real-life object can comprise an inorganic object. Alternatively, the real-life object can comprise a human being. For instance, the human being can be a game player.

In some embodiments, the one or more features of the real-life object can comprise a composition of the real-life object. Alternatively, the one or more features of the real-life object can comprise a category of the real-life object. To determine the game object, the one or more processors can be individually or collectively configured to identify the real-life object based on the spectrometer data. For instance, the one or more processors can be individually or collectively configured to identify the real-life object based on a predetermined mapping between the real-life object and the spectrometer data. In some embodiments, to determine the game object, the one or more processors can be individually or collectively configured to create the game object based on the spectrometer data. Alternatively, to determine the game object, the one or more processors can be individually or collectively configured to select the game object from existing game objects. Alternatively, to determine the game object, the one or more processors can be individually or collectively configured to send the spectrometer data to a spectrometer server over a communication network, and receive information regarding the game object from the spectrometer server, the spectrometer server comprising a database storing and updating spectrometer data associated with real-life objects.

In some embodiments, to perform one or more actions on the game object, the one or more processors can be individually or collectively configured to select the one or more actions from among a plurality of existing actions. Alternatively, to perform one or more actions on the game object, the one or more processors can be individually or collectively configured to update the one or more attributes of the game object. Alternatively, to perform one or more actions on the game object, the one or more processors can be individually or collectively configured to display the one or more attributes of the game object. Alternatively, to perform one or more actions on the game object, the one or more processors can be individually or collectively configured to update a cumulative score. Still alternatively, to perform one or more actions on the game object, the one or more processors can be individually or collectively configured to cause at least one interaction between the game object and one or more other game objects based on the one or more attributes. For instance, the one or more processors can be individually or collectively further configured to update a score based on the at least one interaction. The score can be updated by comparing the one or more attributes of the game object with corresponding one or more attributes of the one or more other game objects.

According to some aspects, the present disclosure discloses a non-transitory computer-readable storage medium with instructions stored thereon that, when executed by a computing system, causes the computing system to perform a method of running a game based on spectrometer data. The method can comprise receiving, from a spectrometer, the spectrometer data of a real-life object from the spectrometer, the spectrometer data indicating one or more features of the real-life object; determining a game object based on the spectrometer data, wherein the game object can have one or more attributes corresponding to the one or more of features of the real-life object; and performing one or more actions on the game object based on the one or more attributes of the game object.

According to some aspects, the present disclosure discloses a method for developing a game based on spectrometer data performed by a game-development device. The method can comprise acquiring a first mapping between a real-life object and spectrometer data of the real-life object, the spectrometer data indicating one or more features of the real-life object; building a second mapping between the spectrometer data and one or more game attributes of a game object, wherein the game object can have one or more attributes corresponding to the one or more features of the real-life object; and creating a plurality of rules that govern a processing of the game object based on the one or more attributes of the game object.

The spectrometer data can comprise a spectrum profile. In some embodiments, the real-life object can comprise an organic object. In some instances, the organic object is food. Optionally, the organic object is a plant. Alternatively, the real-life object can comprise an inorganic object. Alternatively, the real-life object can comprise a human being. For instance, the human being can be a game player. In some embodiments, the one or more features of the real-life object can comprise a composition of the real-life object. Alternatively, the one or more features of the real-life object can comprise a category of the real-life object.

In some embodiments, acquiring the first mapping can comprise sending the spectrometer data to a spectrometer server over a communication network, and receiving information regarding the game object from the spectrometer server. The spectrometer server can comprise a database storing and updating spectrometer data associated with real-life objects. Alternatively, acquiring the first mapping can comprise receiving the first mapping from a spectrometer server over a communication network. The spectrometer server can comprise a database storing and updating spectrometer data associated with real-life objects.

In some embodiments, building the second mapping can comprise identifying the real-life object based on the spectrometer data. In some embodiments, creating a plurality of rules can comprise creating the game object based on the spectrometer data. The method can further comprise receiving the spectrometer data from a remote user device over a communication network, and sending information regarding the game object to the remote user device.

In some embodiments, creating a plurality of rules can comprise updating the one or more attributes of the game object. Alternatively, creating a plurality of rules can comprise displaying the one or more attributes of the game object. Alternatively, creating a plurality of rules can comprise updating a cumulative score. Still alternatively, creating a plurality of rules can comprise causing at least one interaction between the game object and one or more other game objects based on the one or more attributes. In some instances, the method can further comprise updating a score based on the at least one interaction. The score can be updated by comparing the one or more attributes the game object with corresponding one or more attributes of the one or more other game objects.

According to some aspects, the present disclosure discloses a device for developing a game based on spectrometer data. The device can comprise a spectrometer configured to detect spectrometer data of a real-life object; and one or more processors. The one or more processors can be individually or collectively configured to: acquire a first mapping between a real-life object and spectrometer data of the real-life object, the spectrometer data indicating one or more features of the real-life object; build a second mapping between the spectrometer data and one or more game attributes of a game object, wherein the game object can have one or more attributes corresponding to the one or more of features of the real-life object; and create a plurality of rules that govern a processing of the game object based on the one or more attributes of the game object.

The spectrometer data can comprise a spectrum profile. In some embodiments, the real-life object can comprise an organic object. In some instances, the organic object is food. Optionally, the organic object is a plant. Alternatively, the real-life object can comprise an inorganic object. Alternatively, the real-life object can comprise a human being. For instance, the human being can be a game player. In some embodiments, the one or more features of the real-life object can comprise a composition of the real-life object. Alternatively, the one or more features of the real-life object can comprise a category of the real-life object.

In some embodiments, to acquire the first mapping, the one or more processors can be individually or collectively configured to send the spectrometer data to a spectrometer server over a communication network, and receive information regarding the game object from the spectrometer server. The spectrometer server can comprise a database storing and updating spectrometer data associated with real-life objects. Alternatively, to acquire the first mapping, the one or more processors can be individually or collectively configured to receive the first mapping from a spectrometer server over a communication network. The spectrometer server can comprise a database storing and updating spectrometer data associated with real-life objects.

In some embodiments, to build the second mapping, the one or more processors can be individually or collectively configured to identify the real-life object based on the spectrometer data. In some embodiments, the one or more processors can be individually or collectively configured to further receive the spectrometer data from a remote user device over a communication network, and send information regarding the game object to the remote user device.

In some embodiments, to create the plurality of rules, the one or more processors can be individually or collectively configured to create the game object based on the spectrometer data. Alternatively, to create the plurality of rules, the one or more processors can be individually or collectively configured to select the game object from existing game objects. Alternatively, to create the plurality of rules, the one or more processors can be individually or collectively configured to update the one or more attributes of the game object. Alternatively, to create the plurality of rules, the one or more processors can be individually or collectively configured to display the one or more attributes of the game object. Alternatively, to create a plurality of rules, the one or more processors can be individually or collectively configured to update a cumulative score. Still alternatively, to create the plurality of rules, the one or more processors can be individually or collectively configured to cause at least one interaction between the game object and one or more other game objects based on the one or more attributes. In some instances, the one or more processors can be individually or collectively configured to further update a score based on the at least one interaction. The score can be updated by comparing the one or more attributes the game object with corresponding one or more attributes of the one or more other game objects.

According to some aspects, the present disclosure discloses a non-transitory computer-readable storage medium with instructions stored thereon that, when executed by a computing system, causes the computing system to perform a method of developing a game based on spectrometer data. The method can comprise: acquiring, by one or more processors, a first mapping between a real-life object and spectrometer data of the real-life object, the spectrometer data indicating one or more features of the real-life object; building, by the one or more processors, a second mapping between the spectrometer data and one or more game attributes of a game object, wherein the game object can have one or more attributes corresponding to the one or more features of the real-life object; and creating a plurality of rules that govern a processing of the game object based on the one or more attributes of the game object.

According to some aspects, the present disclosure discloses a system of implementing a game based on spectrometer data. The system can comprise the device for running a game based on spectrometer data; the device for developing a game based on spectrometer data, the device for developing a game in communication with the device for running a game; and a spectrometer server in communication with the device for developing a game over a communication network.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present disclosure will be obtained by reference to the following detailed description that sets forth illustrative embodiments, in which the principles of embodiments of the present disclosure are utilized, and the accompanying drawings.

FIG. 1 shows a schematic diagram of a system of running a game based on spectrometer data, in accordance with some embodiments of the present disclosure.

FIG. 2 shows a schematic diagram of the compact spectrometer of FIG. 1, in accordance with some embodiments of the present disclosure.

FIG. 3A and FIG. 3B illustrate a spectrometer system integrated into a mobile phone case, in accordance with some embodiments of the present disclosure.

FIG. 3C illustrates a spectrometer system integrated into a mobile phone, in accordance with some embodiments of the present disclosure.

FIG. 4 shows exemplary spectra of plums and cheeses, in accordance with some embodiments of the present disclosure.

FIG. 5 is a flow chart illustrating a method performed by a user device of running a game based on spectrometer data, in accordance with some embodiments of the present disclosure.

FIG. 6 is a flow chart illustrating a method performed by a game-development device for developing a game based on spectrometer data, in accordance with some embodiments of the present disclosure.

FIGS. 7-10 show an example of a game, which implements a method performed by a user device of running a game based on spectrometer data and a method performed by a game-development device for developing a game based on spectrometer data, in accordance with some embodiments of the present disclosure.

FIGS. 11-14 show another example of a game, which implements a method performed by a user device of running a game based on spectrometer data and a method performed by a game-development device for developing a game based on spectrometer data, in accordance with some embodiments of the present disclosure.

FIGS. 15-19 show another example of a game, which implements a method performed by a user device of running a game based on spectrometer data and a method performed by a game-development device for developing a game based on spectrometer data, in accordance with some embodiments of the present disclosure.

FIGS. 20-22 show another example of a game, which implements a method performed by a user device of running a game based on spectrometer data and a method performed by a game-development device for developing a game based on spectrometer data, in accordance with some embodiments of the present disclosure.

FIG. 23 schematically illustrates an example of a computer system suitable for incorporation with the methods and apparatus in accordance with some embodiments of the present disclosure.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

The configurations disclosed herein can be combined in one or more of many ways to provide improved spectrometer methods and apparatus. One or more components of the configurations disclosed herein can be combined with each other in many ways. A spectrometer as described herein can be used to generate spectral data of the object, and the spectral data of the object transmitted to a cloud based server in order to determine one or more attributes of the object. Alternatively or in combination, data of the cloud based server can be made available to both users and non-users of the spectrometers in order to provide useful information related to attributes of measured objects. The data of the cloud based server can be made available to users and non-users in many ways, for example with downloadable apps capable of connecting to the cloud based server and downloading information related to spectra of many objects.

The configurations disclosed herein are also capable of providing a database of attributes of many objects related to spectral data. A mobile communication device can be configured for a user to input attributes of one or more measured objects in order to construct a database based on spectral data of many measured objects.

As used herein, like characters refer to like elements. As used herein, the term “light” encompasses electromagnetic radiation having wavelengths in one or more of the ultraviolet, visible, or infrared portions of the electromagnetic spectrum.

The electronic games as described herein can be a video game or a handheld electronic game. The game can be a single player game and a multi-player game. The game can be a game running on a local device or an online game that is either partially or primarily played through the Internet or another computer network. The game, as described herein, can run on gaming platforms, including PCs, consoles and mobile devices, and span many genres, including first-person shooters, strategy games and massively multiplayer online role-playing games.

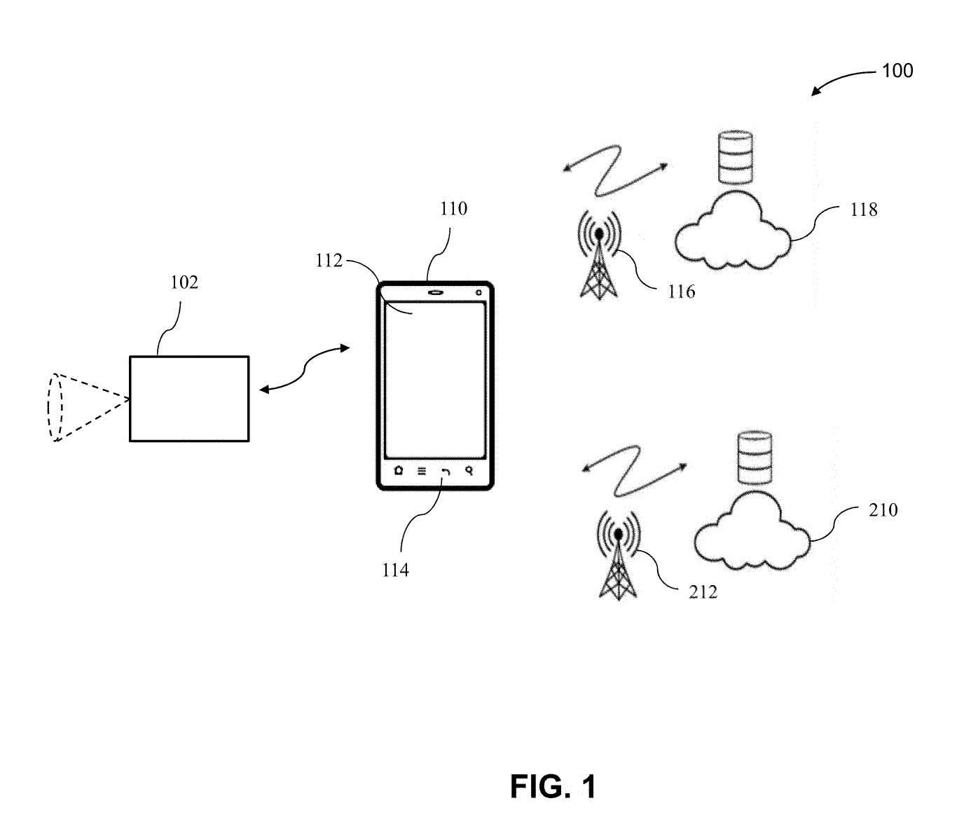

FIG. 1 shows a schematic diagram of a system of running a game based on spectrometer data, in accordance with some embodiments of the present disclosure. In some embodiments, the system 100 can comprise a spectrometer 102 as described herein, and a user device 110, a cloud based spectrometer server 118 and a cloud based game server 210.

The spectrometer 102 can be configured in many ways, and may comprise many prior spectrometers known to one of ordinary skill in the art. The spectrometer 102 typically comprises a range of at least 200 nm, and a resolution finer than 100 nm, for example. In many embodiments, the spectrometer comprises a range of at least 300 nm and a resolution finer than 50 nm. The spectrometer can measure a plurality of wavelengths corresponding to a plurality of separate spectral channels, and the number of spectral channels resolved can be at least four channels, at least five channels, at least 10 channels, or at least 20 channels, for example. Examples of spectrometers suitable for combination in accordance with the present disclosure are described in US20140320858, US20150300879 and US20160299061, the entire disclosures of which are incorporated herein by reference.

The user device 110 can comprise a hand held device, a mobile device, a tablet, a PC, a laptop, or a game console. It will be apparent to those skilled in the art that the user device can be replaced by a video device that produces two- or three-dimensional images, such as a TV. For example, the user device can be a smart phone which comprises a display 112 and an interface 114. The spectrometer 102 can transmit data to and receive data from the user device 110 with a communication link, such as a wireless serial communication link, for example, Bluetooth™. In some instances, the spectrometer 102 can be physically integrated with the user device 110.

The user device 110 can communicate data in wireless communication 116 with the spectrometer server 118. The spectral data of sample subjects acquired by the spectrometer 102 can be processed and analyzed by the spectrometer server 118, and transmitted back to the user device 110 to be displayed to the user. In addition, the analyzed spectral data and/or related additional analysis results can dynamically added to a universal database operated by the spectrometer server 118, where spectral data associated with sample objects can be stored. The spectral data stored on the database can comprise data generated by one or more users of spectrometers, and/or pre-loaded spectral data of materials with known spectra.

The user device 110 can communicate data in wireless communication 212 with the game server 210. The game server is a host which is the authoritative source of events in a video game. For example, a game player can download a game application from the game server, install the game application on the user device 110, and participate in the game by logging onto the game server via the installed application. In some embodiments, the game server 210 can be in wireless communication with the spectrometer server 118. The game server can acquire a copy of a table which records a plurality of spectral data of sample subjects and corresponding sample subjects. Optionally, the spectrometer server and the game server can be integrated into one cloud-based server.

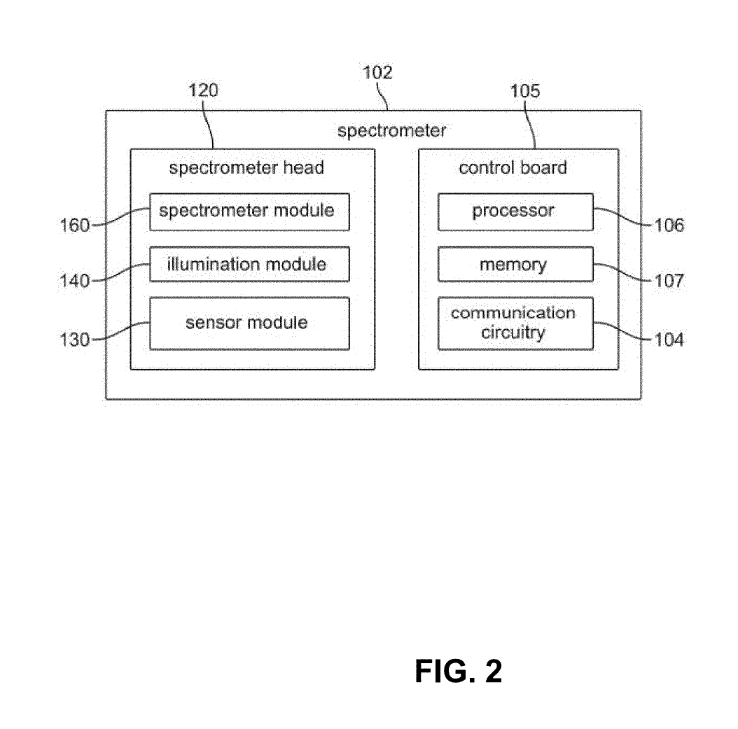

FIG. 2 shows a schematic diagram of the spectrometer 102 of FIG. 1, in accordance with some embodiments of the present disclosure. The spectrometer 102 can comprise a spectrometer head 120 and a control board 105. The spectrometer head 120 can comprise one or more of a spectrometer module 160 and an illumination module 140, which together can be configured to measure spectroscopic information relating to a sample material as described in further detail herein. The spectrometer head 120 can further comprise a sensor module 130, which can be configured to measure non-spectroscopic information relating to a sample material, such as ambient temperature. The control board 105 can comprise one or more of a processor 106, communication circuitry 104, and memory 107. Components of the control board 105 can be configured to transmit, store, and/or analyze data, as described in further detail herein.

The sensor module 130 can enable the identification of the sample material based on non-spectroscopic information in addition to the spectroscopic information measured by the spectrometer module 160. Such a dual information system may enhance the accuracy of detection or identification of the material. The sensor element of sensor module 130 may comprise any sensor configured to generate a non-spectroscopic signal associated with at least one aspect of the environment, including the material being analyzed. For example, the sensor element may comprise one or more of a camera, temperature sensor, electrical sensor (capacitance, resistance, conductivity, inductance), altimeter, GPS unit, turbidity sensor, pH sensor, accelerometer, vibration sensor, biometric sensor, chemical sensor, color sensor, clock, ambient light sensor, microphone, penetrometer, durometer, barcode reader, flowmeter, speedometer, magnetometer, and another spectrometer. The output of the sensor module 130 can be associated with the output of the spectrometer module 160 via at least one processing device of the spectrometer system. The processing device can be configured to receive the outputs of the spectrometer module and sensor module, analyze both outputs, and based on the analysis provide information relating to at least one characteristic of the material.

The spectrometer module 160 can comprise one or more lens elements. Each lens can be made of two surfaces, and each surface may be an aspheric surface. In designing the lens for a fixed-focus system, it may be desirable to reduce the system's sensitivity to the exact location of the optical detector on the z-axis (the axis perpendicular to the plane of the optical detector), in order to tolerate larger variations and errors in mechanical manufacturing. To do so, the point-spread-function (PSF) size and shape at the nominal position may be traded off with the depth-of-field (DoF) length. For example, a larger-than-optimal PSF size may be chosen in return for an increase in the DoF length. One or more of the aspheric lens surfaces of each lens of a plurality of lenses can be shaped to provide the increased PSF size and the increased DoF length for each lens. Such a design may help reduce the cost of production by enabling the use of mass production tools, since mass production tools may not be able to meet stringent tolerance requirements associated with systems that are comparatively more sensitive to exact location of the optical detector.

In some cases, the measurement of the sample subject can be performed using scattered ambient light. In some cases, the spectrometer system may comprise a light or illumination source, such as illumination module 140. The light source can be of any type (e.g., laser, light-emitting diode, etc.) known in the art appropriate for the spectral measurements to be made. The light source may emit from 350 nm to 1100 nm. The light source may emit from 0.1 mW to 500 mW. The wavelength(s) and intensity of the light source can depend on the particular use to which the spectrometer will be put.

The spectrometer as described herein can be adapted, with proper choice of light source, detector, and associated optics, for a use with a wide variety of spectroscopic techniques. Non-limiting examples include Raman, fluorescence, and IR or UV-VIS reflectance and absorbance spectroscopies. Because, as described herein, a compact spectrometer system can separate a Raman signal from a fluorescence signal, the same spectrometer may be used for both spectroscopies. The spectrometer may not comprise a monochromator.

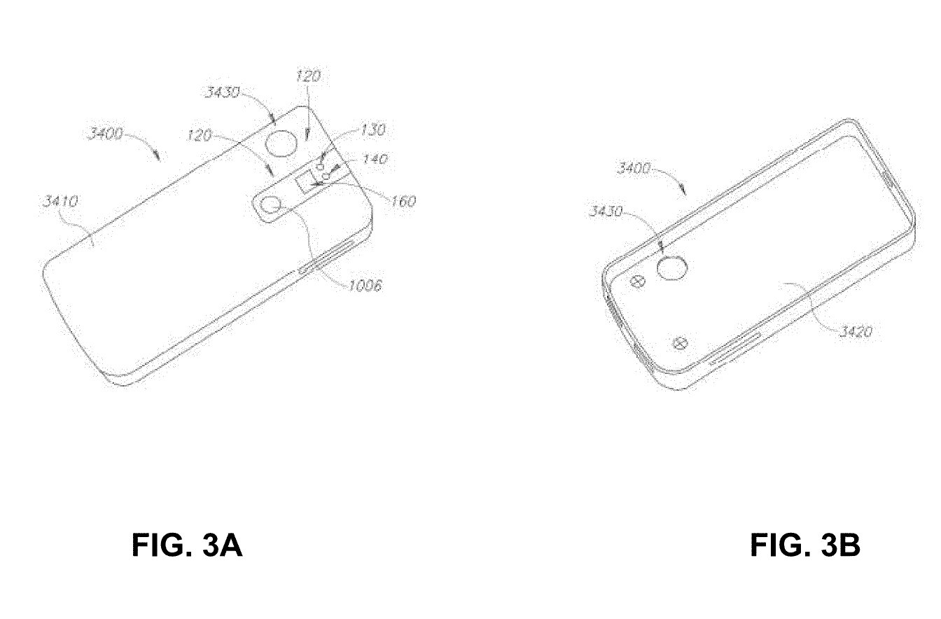

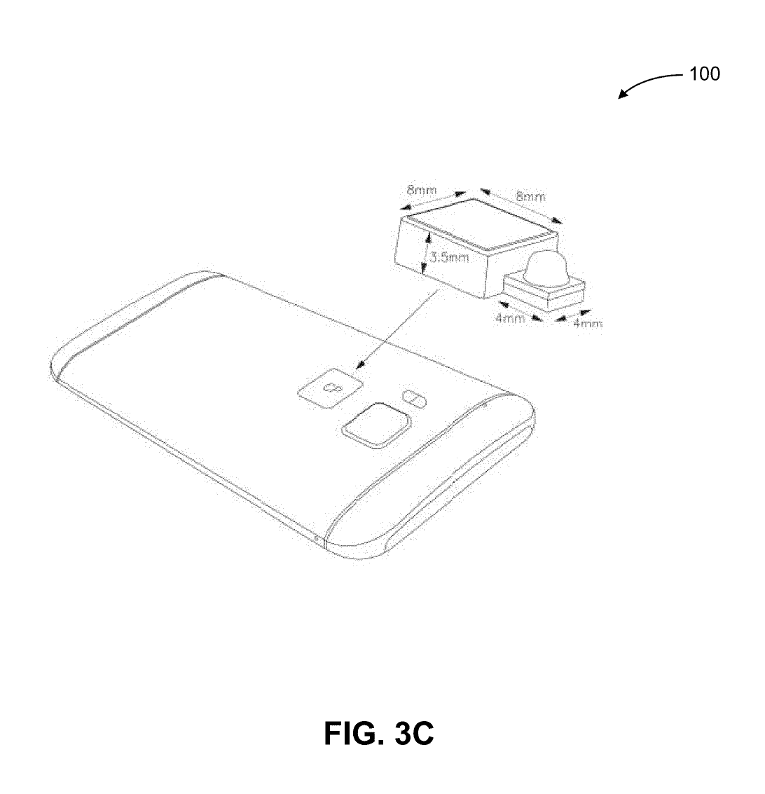

FIG. 3A and FIG. 3B illustrate a spectrometer system integrated into a mobile phone case, in accordance with some embodiments of the present disclosure. FIG. 3C illustrates a spectrometer system integrated into a mobile phone, in accordance with some embodiments of the present disclosure.

FIG. 3A shows the exterior surface 3410 of the mobile phone case 3400 comprising an embedded compact spectrometer. FIG. 3B shows the interior surface 3420 of the phone case 3400. As shown in FIG. 3A, the spectrometer is embedded into the mobile phone case 3400, such that the optical head 120 of the spectrometer is disposed on the exterior surface 3410 of the phone case. The optical head 120 comprises a spectrometer module 160, which includes a detector configured to measure the spectra of a sample. The optical head further comprises an illumination module 140, which includes a light source configured to produce an optical beam configured to illuminate the sample. The optical head can optionally comprise a sensor module 130, which may have one or more sensors configured to collect non-spectral information, such as ambient temperature. The mobile phone case 3400 can comprise an aperture 3430 configured to accommodate a built-in camera of a mobile device used with the case. Components of the optical head 120 may be orientated such that the field of view of the detector of the spectrometer is disposed on the same plane as the field of view of the camera. The field of view of the detector may at least partially overlap with the field of view of camera. The spectrometer can further comprise a user input for controlling the operation of the spectrometer, such as operating button 1006. Embedding the spectrometer in a mobile device case can provide a convenient way for users to store, carry, and use the spectrometer.

A compact spectrometer as described herein may be physically and/or functionally integrated with a smartphone, for example via integration into a housing for a smartphone, such as the mobile phone case 3400 as shown in FIGS. 3A and 3B. Alternatively, the spectrometer may be physically integrated with the smartphone itself as shown in FIG. 3C. For example, the spectrometer can be built into the smartphone, similarly to a smartphone-integrated camera. The smartphone can have various functional features supported by an advanced mobile operating system, such as one or more of a camera, accelerometer, or a global positioning system (GPS). The housing comprising an integrated compact spectrometer can be configured to communicate with the one or more functional features of the smartphone, for example via a connector to connect to a communication port of the smartphone. Alternatively or in combination, the processor of the compact spectrometer may comprise a communication circuitry as described herein (e.g., wireless serial communication link, such as Bluetooth™), such that the spectrometer can transmit and receive data to and from the smartphone. A compact spectrometer, thus functionally integrated with a smartphone, can use one or more functional features of the smartphone to enhance the performance of the spectrometer.

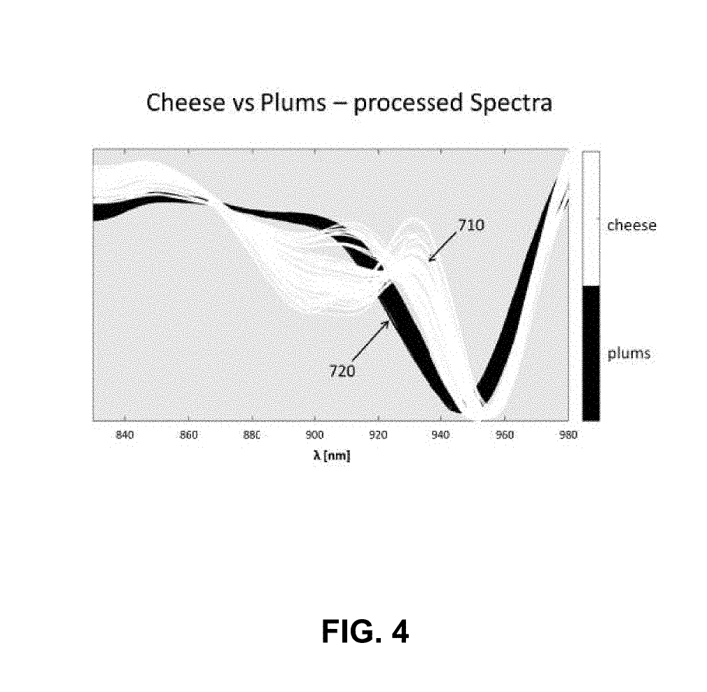

FIG. 4 shows exemplary spectra of plums and cheeses, in accordance with some embodiments of the present disclosure. The spectra of various cheeses 710 and the spectra of various plums 720 are shown to have characteristic features specific to the material type. Characteristic features include, for example, the general shape of the spectra, the number of peaks and valleys in the spectra within a certain wavelength range, and the corresponding wavelengths or wavelength ranges of said peaks and valleys of the spectra. Based on such characteristic features, a spectrometer system as described herein can determine the general identity (e.g., “cheese”, “plum”) of a sampled material, by comparing the measured spectral data against the spectral data of various materials stored in the universal database, as described herein. While FIG. 4 shows the spectra of plums and cheeses in the wavelength range of about 830 nm to about 980 nm, the spectra may be analyzed at any wavelength range that comprises one or more differences between the characteristic features of the spectra of the different materials.

In this way, various real-life objects, including but not limited to food, can be identity by spectrometer against each other based on unique light spectrum thereof. In addition to a chemical composition of the real-life object, at least one of a temperature, a geographic location, a category of a material, a type of a material, a time, an appearance of a material, a color of a material, a taste of a material, a smell of a material, and an observable characteristic associated with a material of real-life object can be recognized by using spectrometers. For example, a sugar level of apples can be detected by spectrometers.

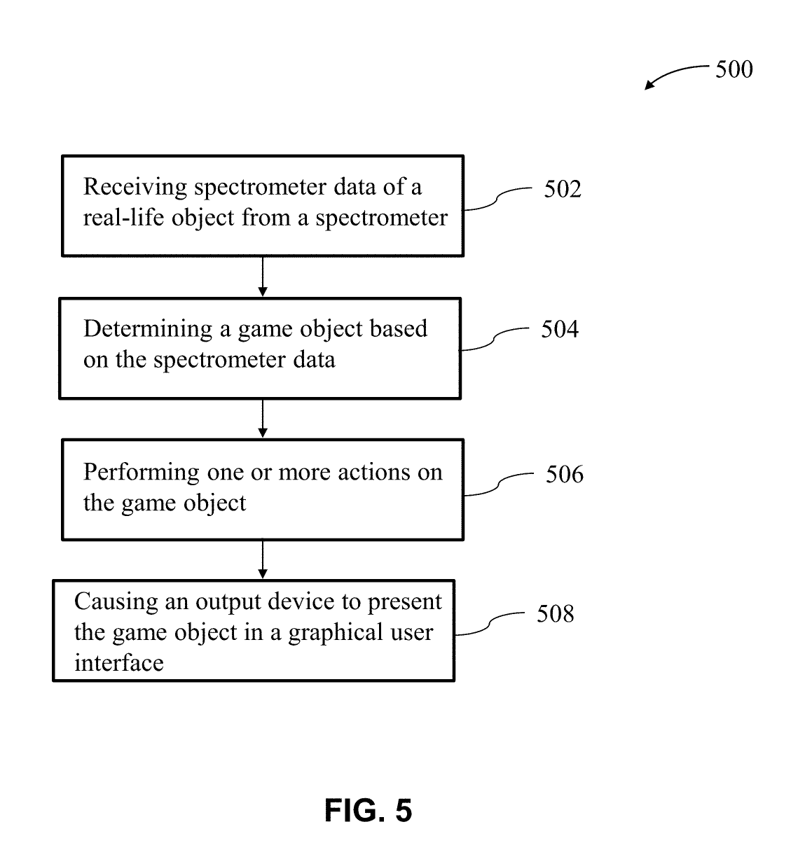

FIG. 5 is a flow chart illustrating a method 500 performed by a user device of running a game based on spectrometer data, in accordance with some embodiments of the present disclosure. The method 500 can be performed by a user device such as a mobile device, a tablet or a game console. For example, the user device can be a smart phone having a processor for running a game program, a display for displaying the game and an interface for receiving user's operation and output game effect (for example, visual data, audio date, and/or tactile feedback such as vibration).

In process 502, spectrometer data of a real-life object can be received from a spectrometer. The spectrometer data can indicate one or more features of the real-life object. In some instances, the spectrometer can be integrated with the user device, as discussed hereinabove. Optionally, the spectrometer can be separate from and communicate with the user device. The real-life object can comprise organic objects (for example, food, pet, or earth) and inorganic objects (for example, steel or glass).

The spectrometer data of the real-life object can comprise a spectrum profile of the real-life object which can distinguish the real-life object from others. The spectrometer data can indicate one or more features of the real-life object. The features of the real-life object can comprise at least one of a temperature, a geographic location, a category of a material, a type of a material, a chemical composition, a time, an appearance of a material, a color of a material, a taste of a material, a smell of a material, and an observable characteristic associated with a material of the real-life object. For example, the real-life object can be an apple, and the spectrometer data of the apple, as measured by the spectrometer, can include at least one of a geographic location, a sugar level, a color, a total fat and a place of origin of the apple.

In process 504, a game object can be determined by one or more processors of the user device based on the spectrometer data. The game object can be an entity within the game, such as a player character, a non-player character or an item. For instance, in a role-playing game, the game object can be a character (for example, a hero) which is controlled by the game player. For another instance, the game object can be an item of the character, such as a “sword” of the hero.

The game object can have one or more attributes. The one or more attributes can indicate a nature or a state of the game object. For instance, in a role-playing game, the attributes of a player character can include at least one of a health point, a value of attack and a value defense of the player character. The one or more attributes of the game object can correspond to the one or more features of the real-life object. For instance, a player character (for example, a hero) of a game can have attributes such as health point which corresponds to a sugar level of an apple which is scanned with a spectrometer.

The one or more attributes of the game object can be modified based on the one or more features of the real-life object. For instance, an attribute of a game object (for example, a value of attack of a sword) can correspond to a feature of the real-life object (for example, sugar level of the apple). By scanning a sweeter apple, the value of attack of a “sword” can be increased.

In some embodiments, determining the game object can comprise identifying the real-life object based on the spectrometer data. For instance, the real-life object can be identified based on a predetermined mapping between real-life object and the spectrometer data. In some instances, the predetermined mapping can be stored locally in the user device, such that the real-life object can be identified by the user device without interacting with a remote server. Optionally, the predetermined mapping can be stored remotely in a remote database. In case the predetermined mapping is stored in a remote database, determining the game object can comprise sending the spectrometer data to a remote server over a communication network, and receiving information regarding the game object from the remote server. The spectral data of the real-life objects acquired by the spectrometer can be transmitted to, processed and analyzed by a spectrometer server where spectral data associated with various objects can be stored. The recognized real-life object information, such as one or more features of the real-life object, can then be transmitted back to the user device.

Alternatively, determining the game object can comprise creating the game object based on the spectrometer data. For instance, a game object can be created based on the features of the real-life object which are indicated by the spectrometer data. In an exemplary embodiment, a player character (for example, a hero) can be created based on features of a real-life object (for example, an apple). For instance, a hero can be created based on a sugar level of an apple which is received from the spectrometer. An attribute of the hero, such as a health point, can correspond to the sugar level of an apple.

Alternatively, determining the game object can comprise selecting the game object from existing game objects. For instance, a plurality of game objects (for example, weapons of a hero, such as a sword, a spear or a bow) can be preset in the game each corresponding to a certain category of vegetable (for example, a carrot, a lettuce or a pepper). Upon determining a category of vegetable with the spectrometer, the game object can be selected, by the game program or the game player, from the existing preset game objects. In an exemplary example, a spear can be selected from among a list of exiting weapons by the game program when spectrometer data indicative of a lettuce is received from the spectrometer.

In process 506, one or more actions can be performed on the game object based on the one or more attributes of the game object. In some embodiments, performing one or more actions on the game object can comprise selecting the one or more actions from among a plurality of existing actions. The existing actions can be preset in the game program. For instance, the existing actions can comprise at least one of creating a game object, displaying the game object from among a plurality of game objects, selecting one or more attributes of the game object, displaying the one or more attributes of the game object, selecting one or more attributes from among a plurality of attributes of the game object, updating the one or more attributes of the game object, updating a cumulative score, and causing at least one interaction between the game object and one or more other game objects based on the one or more attributes.

In some instances, the game object can be displaying on the user device. For example, if a player character such as a “spirit” is created based on the spectrometer data of a scanned apple, which spectrometer data being indicative of a sugar level of the apple, the created “spirit” can be displayed on a screen of the user device using for example an animated image.

Optionally, the one or more attributes of the game object can be updated and displayed. For example, if an attribute of a game object, such as a health point of a player character, is increased based on the spectrometer data of a scanned apple which is indicative of a total fat of the apple, the updated health point of the player character can be displayed on a screen of the user device. The health point can be displayed in a numeral value such as “60/100” or an animated image (such as with a bar that empties itself when the player character loses health point).

Optionally, at least one interaction can be caused between the game object and one or more other game objects based on the one or more attributes. In some instances, the interaction can comprise updating a cumulative score based on the at least one interaction by, for example, comparing the one or more attributes the game object with corresponding one or more attributes of the one or more other game objects. For example, two or more player characters in the game can attack with each other by comparing corresponding one or more attributes. In an exemplary example, a player character A can attack with another player character B by ‘attacking the player character B’. The health point of B can be decreased by a value equal to a value of attack of the player character A each time the player character A initiates a successful attack, and vice versa. The player character B can become incapacitated if the health point thereof is below a predetermined value, and the player of the player character A can be rewarded in some way. The game player of the player character B can restore the health point by scanning new real-life objects which are rich in sugar or consuming certain game items, such as health potions, food or first-aid kits. The game items can be created or upgraded by scanning real-life objects which are rich in sugar.

In process 508, an output device can be caused to present the game object in a graphical user interface. The graphical user interface can be the display, the loudspeaker and/or vibrator of the user device. The processes as discussed hereinabove, for example, but not limited to, creating a game object from scanning real-life objects, selecting the game object from existing game objects, selecting one or more actions from among a plurality of existing actions, updating the one or more attributes of the game object, attacking other game objects, can be displayed on the graphical user interface in an animated manner.

The processes of exemplary method 500 can be performed on a device for running a game based on spectrometer data. The device can comprises a spectrometer configured to detect the spectrometer data of a real-life object, which the spectrometer data being indicative of one or more features of the real-life object, and one or more processors. For instance, the device can comprise a built-in spectrometer, and can communicate with a spectrometer server and a game server. The spectral data of the scanned real-life subjects acquired by the spectrometer can be sent to the spectrometer server, and processed and analyzed by the spectrometer server. The information on the real-life object, such as one or more of features of the real-life object can be transmitted back to the device. The device can run a game program which can be provided and maintained at the game server. For instance, the game server can store thereon account information and progress information of each game player.

The instructions for implementing the processes of exemplary method 500 can be stored in a non-transitory computer-readable storage medium. When executed by a computing system, the instructions can cause the computing system to perform the method of running a game based on spectrometer data. In some embodiments, the non-transitory computer-readable storage medium is one or more physical apparatuses used to store data or programs on a temporary or permanent basis. For instance, the non-transitory computer-readable storage medium comprises flash memory, dynamic random-access memory (DRAM), CD-ROMs, DVDs, flash memory devices, magnetic disk drives, magnetic tapes drives, optical disk drives, and cloud computing based storage.

Although FIG. 5 shows a method performed by a user device of running a game based on spectrometer data, a person of ordinary skill in the art will recognize many variations and adaptations. For example, some of the steps can be deleted, some of the steps repeated, and the steps can be performed in any order.

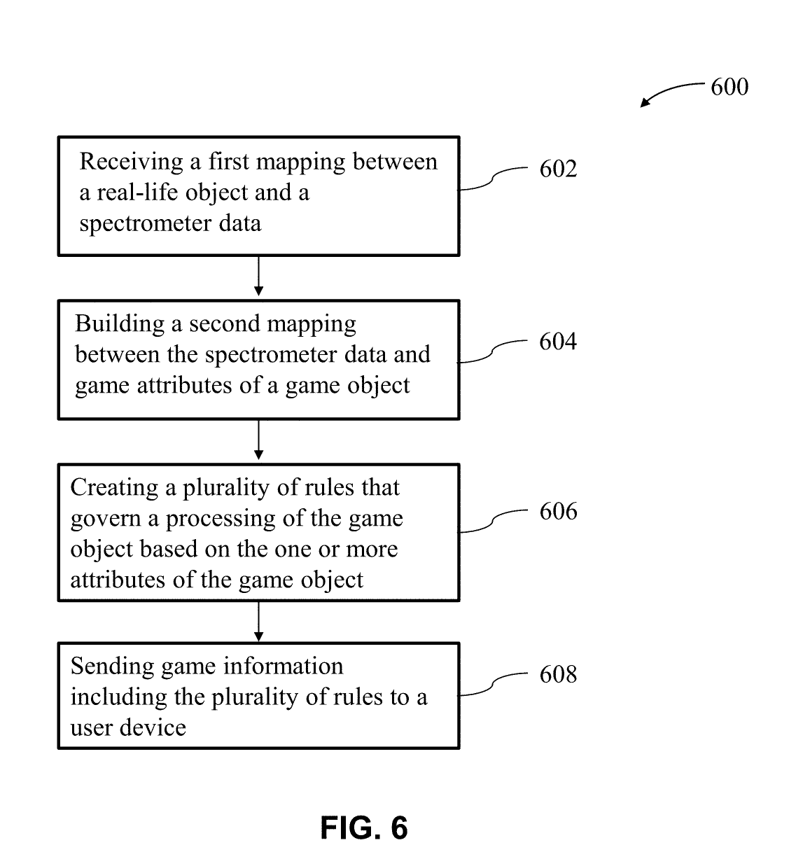

FIG. 6 is a flow chart illustrating a method 600 performed by a game-development device for developing a game based on spectrometer data, in accordance with some embodiments of the present disclosure. The method 600 can be performed by a game-development device such as a game server. For example, a game server can be a host which is the authoritative source of events in a video game. The game server can in wireless communication with the user device. Game players can participate in the game by logging onto the game server.

In process 602, a first mapping between a real-life object and spectrometer data of the real-life object can be acquired by the game server. The spectrometer data of the real-life object can comprise a spectrum profile of the real-life object which can distinguish the real-life object from others. The spectrometer data can indicate one or more features of the real-life object. For example, the real-life object can be a glass of beer, and the spectrometer data of the beer, as measured by the spectrometer, can include at least one of a geographic location, an alcohol level, a chemical composition, a color, a total fat and a place of origin of the beer.

The first mapping between a real-life object and spectrometer data of the real-life object can be acquired by the game server from a spectral database where spectral data associated with sample objects can be stored. The spectral data stored on the spectral database can comprise data generated by one or more users of spectrometers, and/or pre-loaded spectral data of materials with known spectra. The spectral database can be maintained in a remote spectrometer server, as discussed hereinabove. In some instances, the first mapping can be provided in a form of spectral table which records a plurality of spectral data and corresponding sample subjects. A real-life object can thus be recognized from the spectrometer data by searching the first mapping.

In some instances, the first mapping can be stored locally in the game-development device, such that the real-life object can be identified by the game-development device without interacting with a remote spectral database. Optionally, the first mapping can be stored in a remote spectral database. If the first mapping is stored in a remote spectral database, acquiring the first mapping can comprise sending the spectrometer data to the remote spectral database over a communication network, and receiving information regarding the corresponding real-life object from the remote spectral server. For example, the spectral data of the real-life objects acquired by the spectrometer can be transmitted to, processed and analyzed by a spectrometer server where spectral data associated with various objects can be stored. The recognized real-life object information, such as one or more features of the real-life object, can then be transmitted back to the game-development device.

In some instances, acquiring the first mapping can comprise receiving the first mapping from the remote spectral database over a communication network. For instance, the game-development device can store a copy of the first mapping locally, and update it at a predetermined time interval from the remote spectral database.

In process 604, a second mapping between the spectrometer data of a real-life object and one or more game attributes of a game object can be built, by the one or more processors of the game-development device. The game object can be an entity within the game, such as a player character, a non-player character and an item. The game object can have one or more attributes. The one or more attributes can indicate a nature or a state of the game object. For instance, in a role-playing game, the attributes of a player character can include at least one of a health point, a value of attack and a value defense of the player character.

A correspondence between the one or more attributes of a game object and the one or more of features of the real-life object can be built by the game-development device. The process of building the second mapping can comprise setting a correspondence between the spectrometer data of the real-life object and the game attributes of a game object. For instance, an attribute of a player character, for example a value of attack of a hero, can be determined as corresponding to an alcohol level of a beer which is to be scanned by a game player using a spectrometer. The correspondence can be predetermined in developing the game.

In some instances, prompts can be displayed to game players on the correspondence during a game playing. The prompts can provide hint on what category of real-life objects and/or what features of real-life objects can be scanned to upgrade a certain game attribute of the game object. For example, a prompt such as “the hero can have greater value of attack if he has some beer” can be displayed to game players, such that the game players can scan a glass of beer to upgrade corresponding attribute of the game object. The prompt can also provide hint on which one or more attributes of the game object the features of scanned real-life objects correspond to. For example, when a game player scans a rose flower, a prompt such as “this flower can add power to your health potion” can be displayed to game players, such that the game players can select the correct attributes of correct game object (in this example, power of health potion) to be upgraded with the scanned rose flower.

In some embodiments, building the second mapping between the spectrometer data of the real-life object and one or more game attributes of the game object can comprise identifying the real-life object based on the spectrometer data. For instance, the real-life object can be identified by searching the first mapping which is acquired in process 602.

In process 606, a plurality of rules that govern a processing of the game object can be created based on the one or more attributes of the game object. The rules can comprise one or more actions to be performed on the game object. The rules can be preset in developing the game program, and/or modified by game players. For instance, the rules can comprise at least one of creating a game object, selecting a game object from existing game objects, selecting one or more attributes of a game object, updating the one or more attributes of a game object, displaying a game object, displaying one or more attributes of a game object, or updating a cumulative score.

In some instances, the rule can be creating a game object based on the spectrometer data. For example, a game object can be created based on the features of the real-life object which are indicated by the spectrometer data. In an exemplary embodiment, a player character (for example, a hero) can be created based on features of a real-life object (for example, an apple). For instance, different heroes can be created based on various sugar levels of apples which are received from the spectrometer. An attribute of the hero, such as a health point, can correspond to the sugar level of an apple.

Optionally, the rule can be displaying a game object on the user device. For example, if a player character such as a “spirit” is created based on the spectrometer data of a scanned apple, which spectrometer data being indicative of a sugar level of the apple, rule can cause the created “spirit” displayed on a screen of a user device.

Optionally, the rule can be selecting a game object from existing game objects. For example, a series of game items, such as different weapons of a player character, each corresponding to different total fat value of different food, can be preset in the game. A game item can be selected from among the preset series of game items when the game player scans a food having corresponding total fat value.

Optionally, the rule can be updating the one or more attributes of the game object and/or displaying the one or more attributes of the game object. For example, if an attribute of a game object, such as a health point of a player character, is increased based on the spectrometer data of a scanned sandwich which is indicative of a total fat of the sandwich, the updated health point of the player character can be displayed on a screen of the user device.

Optionally, the rule can be updating a cumulative score. For example, a cumulative score can be updated by comparing the one or more attributes the game object with corresponding one or more attributes of the one or more other game objects. In an exemplary example, two or more player characters in the game can attack each other by comparing corresponding one or more attributes. A player character A can attack another player character B by ‘attacking the player character B’. The health point of B can be decreased by a value equal to a value of attack of the player character A each time the player character A initiates a successful attack, and vice versa. The player character B can become incapacitated if the health point thereof is below a predetermined value, and the player of the player character A can be rewarded in some way. The game player of the player character B can restore the health point by scanning new real-life objects with is rich in sugar or consuming certain game items, such as health potions, food or first-aid kits. The game items can be created or upgraded by scanning real-life objects which are rich in sugar.

In process 608, game information including the plurality of rules can be sent to a user device. The game information, including for example the plurality of rules that govern a processing of the game object, game data for building the game environment, object data for displaying the game objects and/or game player data for restoring a previous progress, can be sent to a user device through wireless communication or wired communication. The game information implements all interaction between the game player and the game via a graphical user interface in an animated manner.

Although FIG. 6 shows a method performed by a game-development device for developing a game based on spectrometer data in accordance with some embodiments of the present disclosure, a person of ordinary skill in the art will recognize many variations and adaptations. For example, some of the steps can be deleted, some of the steps repeated, and the steps can be performed in any order. Further, the steps of any method as described herein can be combined with steps from any other method as described herein.

Exemplary examples on methods performed by a user device of running a game based on spectrometer data and methods performed by a game-development device for developing a game based on spectrometer data will be given hereinafter in form of video games. It is apparent to those skilled in the art the provided examples are illustrative only.

### EXAMPLES

### Example 1 “Battle Spirits”

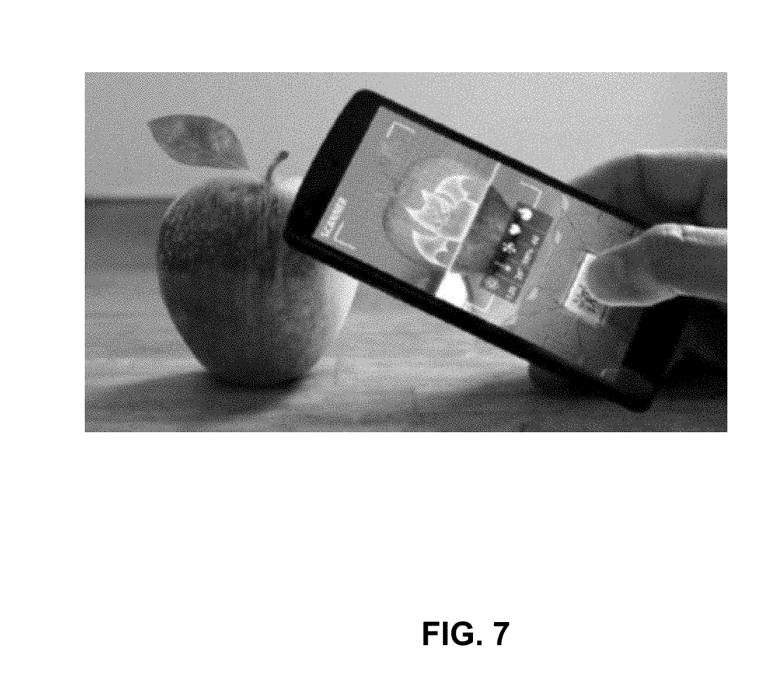

FIGS. 7-10 show an example of a game, which implements a method performed by a user device of running a game based on spectrometer data and a method performed by a game-development device for developing a game based on spectrometer data, in accordance with some embodiments of the present disclosure. The exemplary example can be explained with reference to a game named “Battle Spirits”.

In this example, as shown in FIG. 7, a game player can scan real-life objects with spectrometer to determine one or more game objects, modify one or more attributes of the game object, and perform interaction between the game object and one or more other game objects within the game.

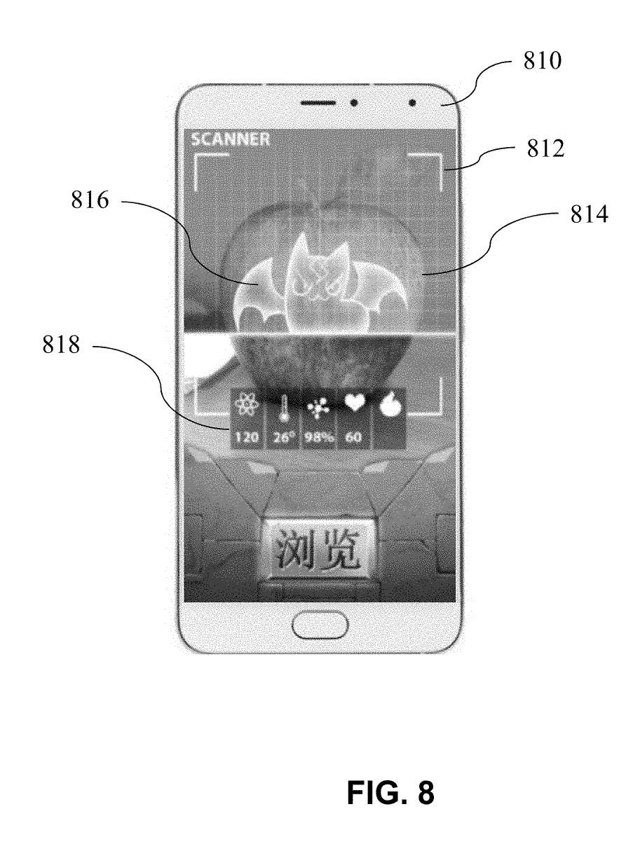

As shown in FIG. 8, the game player can scan a real-life object with a user device 810 and determine a game object. The user device 810 can be for example a hand held device which comprises a display 812 and a camera (not shown). The user device 810 can comprise a spectrometer (not shown) which is integrated with the user device. For example, the spectrometer can be embedded into a case of the user device at a rear side of the user device. The spectrometer can be provided on a same side with the camera of the user device, such that a mix of real scene (for example, the real-life object captured by the camera) and a virtual scene of the game can be displayed on the display of the user device.

Within the game, the game player can scan a real-life object. Spectrometer data of the real-life object can be received from the spectrometer, which spectrometer data indicating one or more features of the real-life object. The spectrometer data of the real-life object can comprise spectrum profile of the real-life object which can distinguish the real-life object from others. The features of the real-life object can comprise at least one of a temperature, a geographic location, a category of a material, a type of a material, a chemical composition, a time, an appearance of a material, a color of a material, a taste of a material, a smell of a material, and an observable characteristic associated with a material of the real-life object.

Upon user scanning the real-life object, one or more game objects can be determined based on the spectrometer data of the scanned real-life object. In some embodiments, determining a game object can be creating a game object. Alternatively, determining a game object can be selecting a game object from among a plurality of existing game objects. The game object can be an entity within the game, such as a player character, a non-player character and an item. The game object can have one or more attributes. The one or more attributes can indicate a nature or a state of the game object. For instance, in a role-playing game, the attributes of a player character can include at least one of a health point, a value of attack and a value defense of the player character. The one or more attributes of the game object can correspond to the one or more features of the real-life object. For instance, a player character (for example, a hero) of a game can have attributes such as health point which corresponds to a sugar level of an apple which is scanned with a spectrometer.

In the exemplary example shown in FIG. 8, a real-life apple 814 can be scanned with the spectrometer. The spectrometer data of the scanned apple can be received from the spectrometer. The apple and one or more features of the apple can be identified based on a predetermined mapping between the apple and spectrometer data of the apple. In some instances, the spectrometer data of the scanned apple can be transmitted to, processed and analyzed by a remote spectrometer server where spectral data associated with various objects can be stored. The recognized real-life object information, such as one or more features of the apple, can then be transmitted back to the user device. A game object can then be determined based on the spectrometer data of the scanned apple, which the game object has one or more attributes corresponding to the one or more features of scanned apple. For instance, a game object such as “spirit” 816 can be created based on features of the scanned apple including a size, a sugar level, a total fat, an origin of product, etc. Optionally, the “spirit” 816 can be selected from a plurality of existing “spirits” which are preset in the game, based on features of the scanned apple. A mix of real scene of the apple 814 and a virtual scene of the game including the “spirit” 816 can be displayed on the display of the user device. Attributes 818 of the “spirit” can be displayed on the user device. The attributes of the “spirit”, such as a health point, a value of attack and a value of defense, can correspond to the one or more features of the scanned apple.

One or more actions can be performed on the game object “spirit” based on the one or more attributes of the game object. In some embodiments, performing one or more actions on the game object can comprise selecting the one or more actions from among a plurality of existing actions. The existing actions can be preset in the game program. For instance, the existing actions can comprise at least one of creating a game object, selecting the game object from among a plurality of existing game objects, selecting one or more attributes of the game object, displaying the one or more attributes of the game object, updating the one or more attributes of the game object, changing an appearance of the game object, updating a cumulative score, or causing at least one interaction between the game object and one or more other game objects based on the one or more attributes.

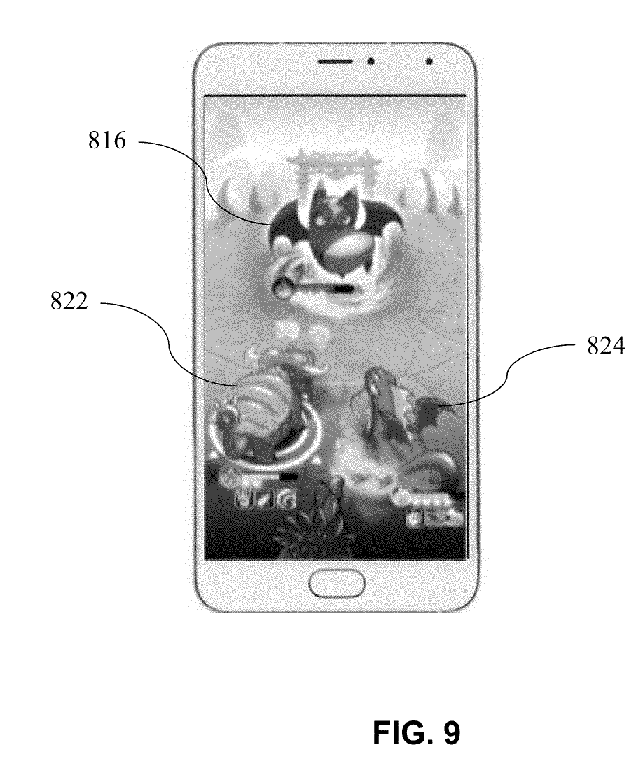

In some embodiments, the one or more actions on the game object can comprise causing at least one interaction between the game object and one or more other game objects. As shown in FIG. 9, the game object “spirit” 816 can be displayed on the user device and interact with other game objects “spirits” 822 and 824 within the game. The other game objects “spirits” 822 and 824 can be existing game objects which are provided by the game program, or game objects created and controlled by other game player (for example, in an online multi-player game). In some instances, the interaction between game objects can comprise updating a cumulative score based on the at least one interaction by, for example, comparing the one or more attributes the game object with corresponding one or more attributes of the one or more other game objects. For example, the game object can attack each other by comparing corresponding one or more attributes. In an exemplary example, a player character A can attack game objects “spirits” 822 and 824 by attacking the player characters “spirits” 822 and/or 824. The health point of player characters “spirits” 822 and/or 824 can be decreased by a value equal to a value of attack of the player character “spirit” 816 each time the player character “spirit” 816 initiates a successful attack, and vice versa. The player characters “spirits” 822 and/or 824 can become incapacitated if the health point thereof is below a predetermined value, and the player of the player character “spirit” 816 can be rewarded in some way. For example, the defeated player characters “spirits” 822 and/or 824 can be caught and owned by the game player.

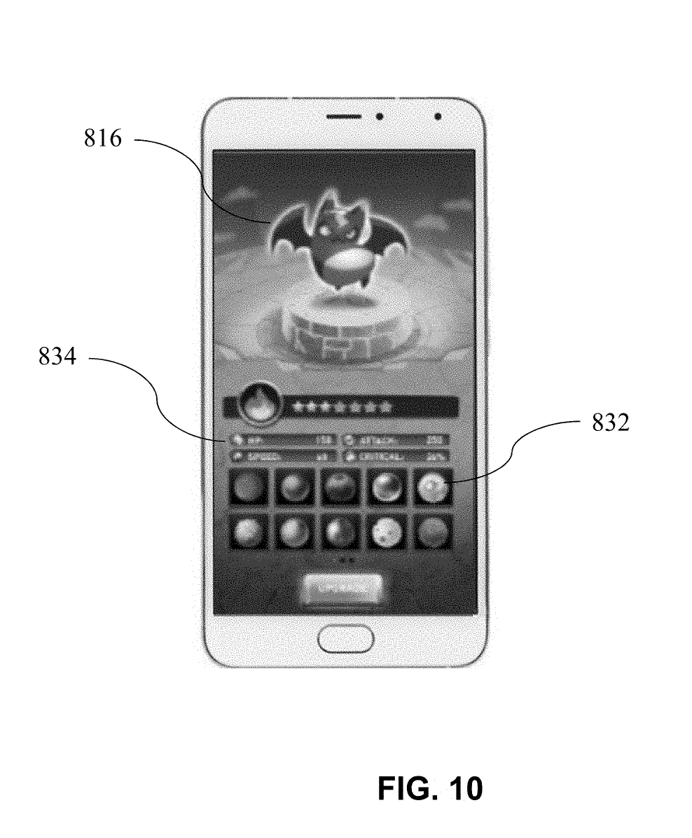

Alternatively and/or additionally, the one or more actions on the game object can comprise updating the one or more attributes of the game object. As shown in FIG. 10, the one or more attributes of the game object “spirit” 816 can be updated and displayed. For example, an attribute of a game object, such as a health point of the “spirit”, can be increased by scanning real-life food. The features of the scanned food 832 as indicated by spectrometer data, such as a total fat, a sugar level, a size and a temperature, can each increase an attribute 834 of the game object “spirit”, such as a health point, an attack, a speed and a critical. A correspondence between the attributes of the game object and the features of the real-life objects can be predetermined as game rules within the game.

In the exemplary game, the game player can care for and upgrade the game object (for example, “spirit”) by feeding it, for example by scanning real-life food. The more nutritious the food is, the more health point or other attributes can be increased. The game player can start with one “spirit” but eventually manage a full roster of “spirits” by creating new “spirit”, each “spirit” being different in stats and visuals. Each game player can have a limited number of active “spirits” in a hatchery. Each “spirit” can bear a conceptual relation with the scanned real-life object from which the game object is created or selected. The “spirit” can have different types of attack, for example one normal attack and three special attacks. The normal attack can be always active unless the “spirit” is interfered with by an enemy. The special attack can be active when a cool-down timer is ended. During the game player's turn, the game player can select one “spirit”, and select a desired attack and then swipe from the center of the “spirit” towards the enemy. At certain points the game player can be able to evolve his/her “spirits”, thus creating a much stronger version of the “spirit”. The player can also find items to equip the “spirits” with, which are made from various real-life objects he/she finds. For example, prompt can be provided to the game player, such that the game player can scan a steel item to equip the “spirit”.

The exemplary game can allow social elements such as battling other player's “spirits”, ranking in leaderboards, sharing and bragging. The “spirit” can carry some parameter from the real-life objects in which they are found. For example, the sweeter the apple is, the cuter the “spirit” can be. The scanning can comprise a normal scanning and a major scan. A normal scanning can be scans on game items such as evolution materials. A timer can be set to allow a new normal scanning, for example a short timer of 30 seconds. The normal scanning can be performed many times a day. A major scanning can enable the game player to create a “spirit”. A timer can be set to allow a new major scanning, for example a longer timer of one hour. The major scanning can be performed limited times a day and if the game player has a space in the hatchery.

In the exemplary game “Battle Spirits”, a method performed by a user device of running a game based on spectrometer data can be implemented. The spectrometer data of a real-life object (for example, an apple) can be received from a spectrometer. The spectrometer data can indicate one or more features of the real-life object (for example, a total fat, a sugar level, a size and a temperature of the apple). A game object (for example, “spirit”) can be determined based on the spectrometer data. The game object can have one or more attributes (for example, a health point, an attack, a speed and a critical feature of the “spirit”) corresponding to the one or more features of the real-life object. One or more actions can be performed on the game object based on the one or more attributes of the game object. For example, the “spirit” and attributes of the “spirit” can be displayed, and the “spirit” can fight with other “spirits” within the game.

In the exemplary game “Battle Spirits”, a method performed by a game-development device for developing a game based on spectrometer data, as illustrated in can be implemented. A first mapping between a real-life object and spectrometer data of the real-life object can be acquired at the game-development device such as a game server. The spectrometer data can indicate one or more features of the real-life object (for example, a total fat, a sugar level, a size and a temperature of the apple). A second mapping between the spectrometer data and one or more game attributes of a game object can be built by the one or more processors of the game-development device. The game object can have one or more attributes (for example, a health point, an attack, a speed and a critical feature of the “spirit”) corresponding to the one or more of features of the real-life object. A plurality of rules that govern a processing of the game object can be created based on the one or more attributes of the game object. For example, the rules specifying how the “spirit” interacts with other “spirits” within the game can be determined at the game server. Game information, including the plurality of rules, can be sent to the user device where interaction between the game player and the game can be implemented via a graphical user interface.

### Example 2 “Monster Evolution”

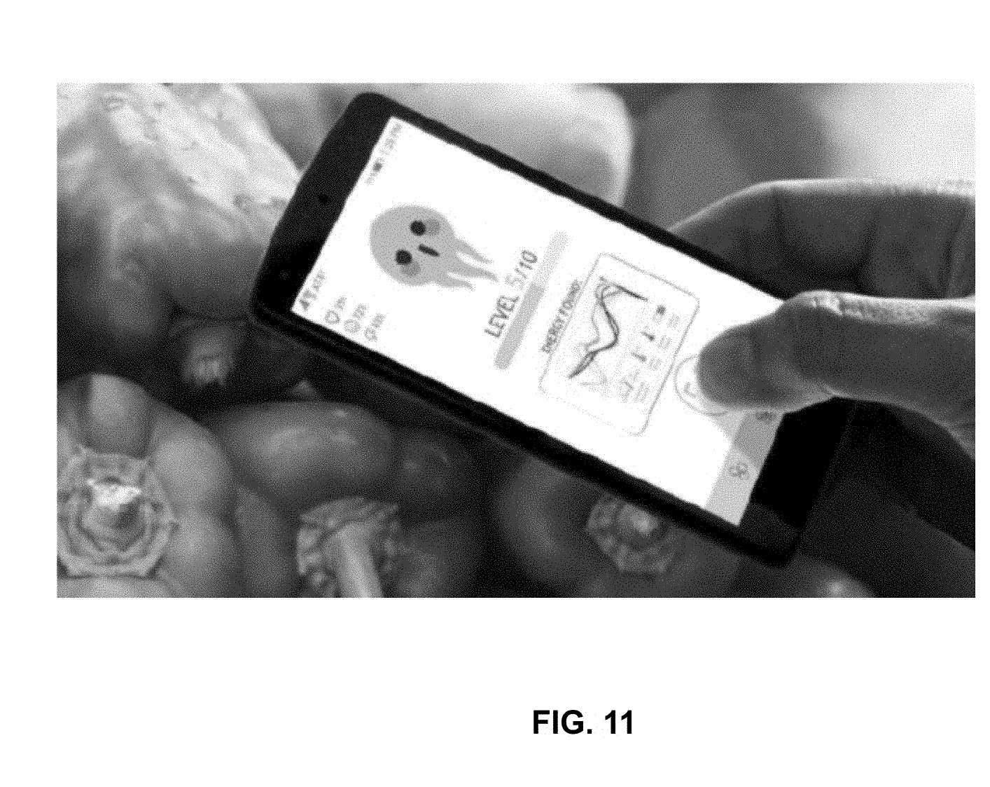

FIGS. 11-14 show another example of a game, which implements a method performed by a user device of running a game based on spectrometer data and a method performed by a game-development device for developing a game based on spectrometer data, in accordance with some embodiments of the present disclosure. The exemplary example can be explained with reference to a game named “Monster Evolution”.

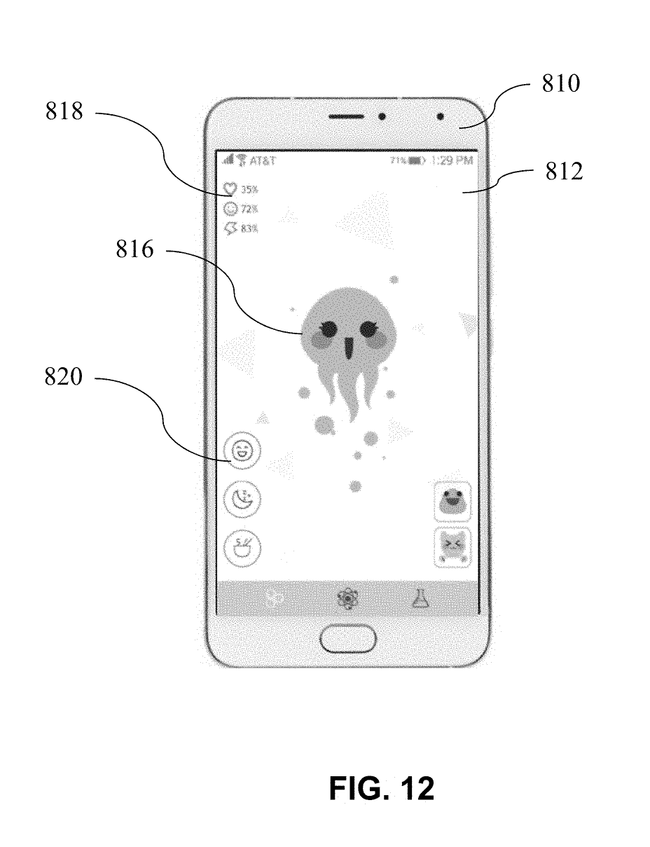

In this example, as shown in FIG. 11, a game player can scan real-life objects with spectrometer to determine one or more game objects, and modify one or more attributes of the game object in various ways. As shown in FIG. 11 and FIG. 12, the game player can scan a real-life object with a user device 810 and determine a game object. The user device 810 can be for example a hand held device which comprises a display 812 and a camera (not shown). The user device 810 can comprises a spectrometer (not shown) which is integrated with the user device. Spectrometer data of the real-life object can be received from the spectrometer, which spectrometer data indicating one or more features of the real-life object. The spectrometer data of the real-life object can comprise spectrum profile of the real-life object which can distinguish the real-life object from others. The features of the real-life object can comprise at least one of a temperature, a geographic location, a category of a material, a type of a material, a chemical composition, a time, an appearance of a material, a color of a material, a taste of a material, a smell of a material, and an observable characteristic associated with a material of the real-life object.

One or more game objects can be determined based on the spectrometer data of the scanned real-life object. In some embodiments, determining a game object can be creating a game object. Alternatively, determining a game object can be selecting a game object from among a plurality of existing game objects. The game object can be an entity within the game, such as a player character, a non-player character and an item. The game object can have one or more attributes. The one or more attributes can indicate a nature or a state of the game object. The one or more attributes of the game object can correspond to the one or more features of the real-life object, such that the game object can carry some parameters/features from the real-life object from which it is created/selected. For instance, an item object (for example, a sword) within a game can have attributes such as value of attack which corresponds to a rigidity of a material (for example, a steel, a glass, a wood or a plastic) which is scanned with a spectrometer.

In the exemplary example shown in FIGS. 11-14, a real-life pepper can be scanned with the spectrometer. The spectrometer data of the scanned pepper can be received from the spectrometer. The pepper and one or more features of the pepper can be identified based on a predetermined mapping between the pepper and spectrometer data of the pepper. In some instances, the spectrometer data of the scanned pepper can be transmitted to, processed and analyzed by a remote spectrometer server where spectral data associated with various objects can be stored. The recognized real-life object information, such as one or more features of the pepper, can then be transmitted back to the user device. A game object can then be determined based on the spectrometer data of the scanned pepper, which the game object has one or more attributes corresponding to the one or more features of scanned pepper. For instance, a game object such as “monster” 816 can be created based on features of the scanned pepper including a size, a spicy level, a total fat, an origin of product, etc. Optionally, the “monster” 816 can be selected from a plurality of existing “monsters” which are preset in the game, based on features of the scanned pepper. Attributes 818 of the “monster” can be displayed on the user device. The attributes of the “monster”, such as a health point, a level of happiness and a level of evolution, can correspond to the one or more features of the scanned pepper.

One or more actions can be performed on the game object “monster” 816 based on the one or more attributes of the game object. In some embodiments, performing one or more actions on the game object can comprise selecting the one or more actions from among a plurality of existing actions. The existing actions can be preset in the game program. For instance, the existing actions can comprise at least one of creating a game object, selecting the game object from among a plurality of existing game objects, selecting one or more attributes of the game object, displaying the one or more attributes of the game object, updating the one or more attributes of the game object, changing an appearance of the game object, updating a cumulative score, causing at least one interaction between the game player and the game object, or causing at least one interaction between the game object and one or more other game objects based on the one or more attributes.

In some embodiments, the one or more actions on the game object can comprise causing at least one interaction between the game player and the game object. For example, as shown in FIG. 12, a list of available interaction 820 between the game player and the game object “monster” 816 can be displayed on the game interface, including such as “having a talk”, “having a sleep” and “having a food”. The game player can interact with the game object “monster” by, for example, feeding it. The feeding can be scanning real-life food and increase an attribute of the game object “monster” (for example, health point) based on corresponding features of the scanned real-life food. A correspondence between the attributes of the game object and the features of the real-life objects can be predetermined as game rules within the game.

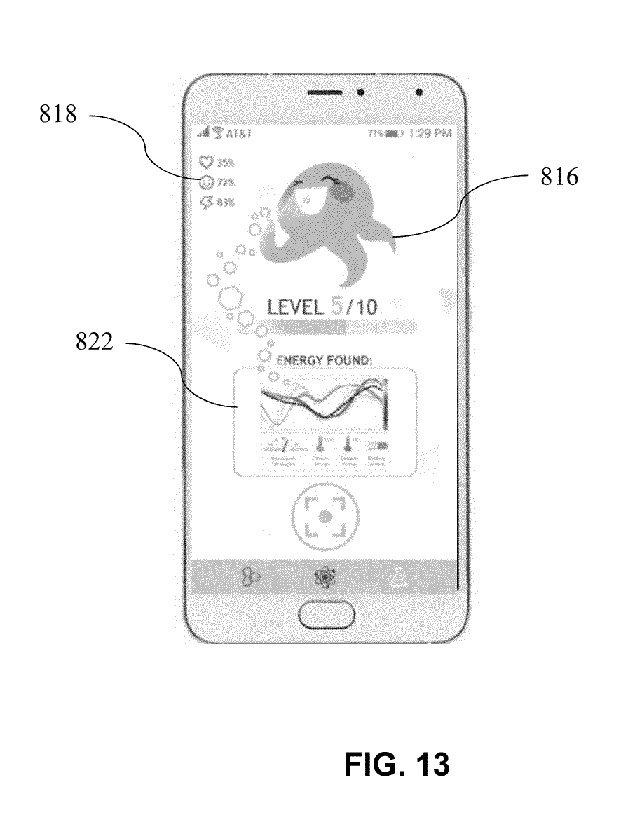

Alternatively and/or additionally, the one or more actions on the game object can comprise updating the one or more attributes of the game object. As shown in FIG. 13, the one or more attributes 818 of the game object “monster” 816 can be updated and displayed. For example, an attribute of a game object, such as a health point of the “monster”, can be increased by scanning real-life food. The features of the scanned food as indicated by spectrometer data, such as a total fat, a sugar level, a size and a temperature, can each increase an attribute of the game object “monster”, such as a health point, a level of happiness and a level of evolution. The features 822 of the scanned food can be displayed on the user device, for example by illustrative curves.

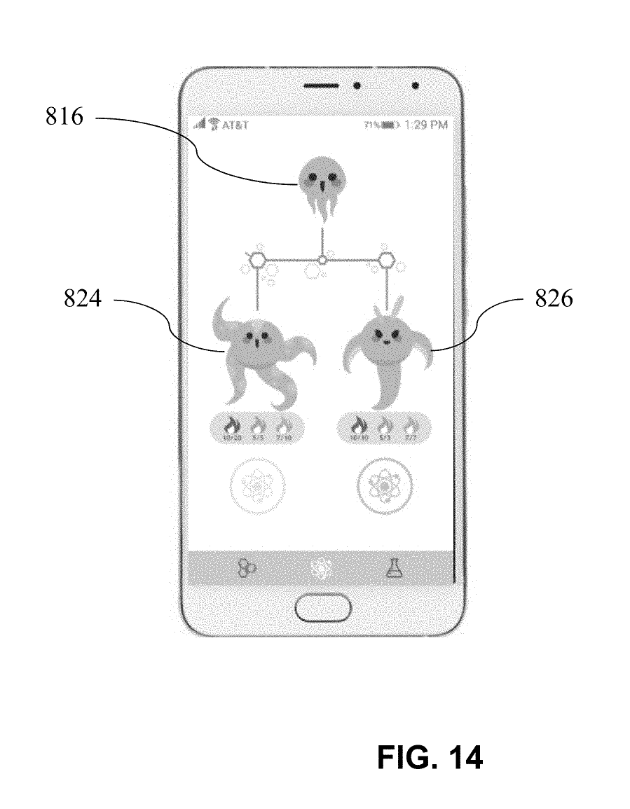

Alternatively and/or additionally, the one or more actions on the game object can comprise changing an appearance of the game object based on one or more attributes of the game object. As shown in FIG. 14, an appearance of the game object “monster” 816 can change by evolving along various paths with various options. For example, under certain conditions, options regarding evolution paths can be provided to the game player, such that the game player can determine how the game object “monster” evolves. The conditions can comprises at least one of, for example, one or more attributes of the game object reaching a predetermined level, a total time of playing of the game player reaching a predetermined amount, or one or more new game objects being created or selected. Options can be provided to the game player on available evolutionary paths. In some instances, the game player can be prompted on what he needs for his desired evolution choice. Optionally, the game object “monster” can evolve according to what the player has already found. For example, the options on two evolutionary paths 824 and 826 can be provided to the game player, as shown in FIG. 14. The evolutionary paths 824 and 826 can be determined by the game program (for example, by game rules received from the game server) according to what the player has already found. The evolution can be combining two or more “monsters” the player already has.

In the exemplary Tamagotchi-like game, a game player can start from a “monster” cell and raise adult cute “monsters”. The game lets the player raise a pet “monster” from a single cell to a mature (cute) “monster”. The player takes care of the pets they find, feeds them and plays with them. The player takes these pets on an evolutionary path full of options and surprises. When they are grown, the player can sell his pets or keep them. The player starts with one pet “monster” but will be able to raise up to, for example, 3 in parallel. The game focuses on the evolution process, offering plenty of choice and different evolution paths enabling a huge amount of unique creatures.

The game player can scan real-life objects to create or find “monster” cells, and combine them to create a small “monster”. The “monster” can join the player's “monster” tank (for example, mobile device). Once in the tank, the cell can start growing and the player will need to keep it alive. The “monster” will require the player to perform actions that revolves around educating it, having fun with it as well as some culinary requirements. The player may need to perform these tasks daily, and performing these tasks close to the right time will provide the player/monster with a bonus. The player may need to upgrade a “monster” by feeding it, and charging it with energy that is sipped out of real-life objects. Each “monster” will have various graphical stats (for example, bars). Every time the player feeds/charges the “monster”, he/she will be able to see clearly in what aspects the “monster” has progressed. Feed can be an active feeding or a passive feeding. A passive feeding is from real-life items the player found by scanning the environment, and an active feeding is by selecting a “monster” and sipping energy from items for a few seconds.

At a few points during the upgrade stage, the player can be able to evolve the “monster” into a new more progressed/unique type. This can happen by presenting the player with few options for an evolutionary path. The player may have to find what he needs for his desired evolution choice, or may evolve according to what he has already found. Different evolution paths lead to different “monster” ratings, different value, and different rewards. A picture of what is scanned can be taken, which can be saved in a “monster” evolution chart and can help the player in the future when looking for specific materials.

The player can also show off his “monsters” by engaging in the many social aspects of the game, like Facebook sharing, “monster” sales, leaderboards etc. All can reward the players with virtual currency and new types of cells. The player can share his “monster” with friends, allowing them to interact with each other (for example, form friendships and share the treatment of the pet “monsters” with your friend). Instead of creating or finding “monsters” on objects, the player can produce a family of “monsters” by scanning family/friends. Being part of other people's family of pets can produce bonuses. The player can scan himself and produce a unique pet. AR, GPS, and Gyro support can be used when playing with the “monsters” and during mini games. As the game progresses, more features can be unlocked, such as different mini games and other items the player may scan.

In the exemplary game “Monster Evolution”, a method performed by a user device of running a game based on spectrometer data can be implemented. The spectrometer data of a real-life object (for example, a pepper) can be received from a spectrometer. The spectrometer data can indicate one or more features of the real-life object (for example, a total fat, a spicy level, a size and a temperature of the pepper). A game object (for example, “monster”) can be determined based on the spectrometer data. The game object can have one or more attributes (for example, a health point, a level of happiness and a level of evolution of the “monster”) corresponding to the one or more features of the real-life object. One or more actions can be performed on the game object based on the one or more attributes of the game object. For example, at least one interaction can happen between the game player and the game object.

In the exemplary game “Monster Evolution”, a method performed by a game-development device for developing a game based on spectrometer data can be implemented. A first mapping between a real-life object and spectrometer data of the real-life object can be acquired at the game-development device such as a game server. The spectrometer data can indicate one or more features of the real-life object (for example, a total fat, a spicy level, a size and a temperature of the pepper). A second mapping between the spectrometer data and one or more game attributes of a game object can be built by the one or more processors of the game-development device. The game object can have one or more attributes (for example, a health point, a level of happiness and a level of evolution of the “monster”) corresponding to the one or more of features of the real-life object. A plurality of rules that govern a processing of the game object can be created based on the one or more attributes of the game object. For example, the rules specifying how the game player can interact with the “monster” and how the “monster” can evolve within the game can be determined at the game server. Game information including the plurality of rules can be sent to the user device where interaction between the game player and the game can be implemented via a graphical user interface.

### Example 3 “Battle Craft”

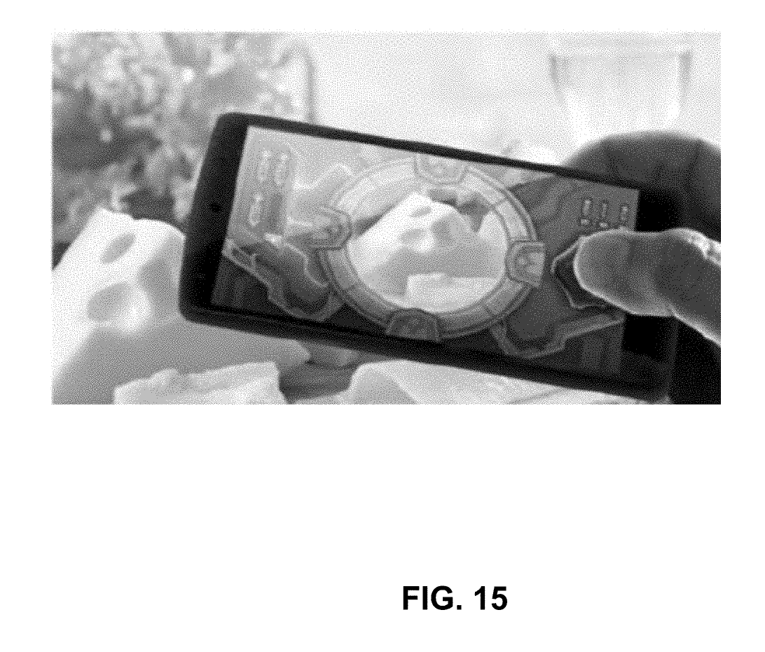

FIGS. 15-19 show another example of a game, which implements a method performed by a user device of running a game based on spectrometer data and a method performed by a game-development device for developing a game based on spectrometer data, in accordance with some embodiments of the present disclosure. The exemplary example can be explained with reference to a game named “Battle Craft”.

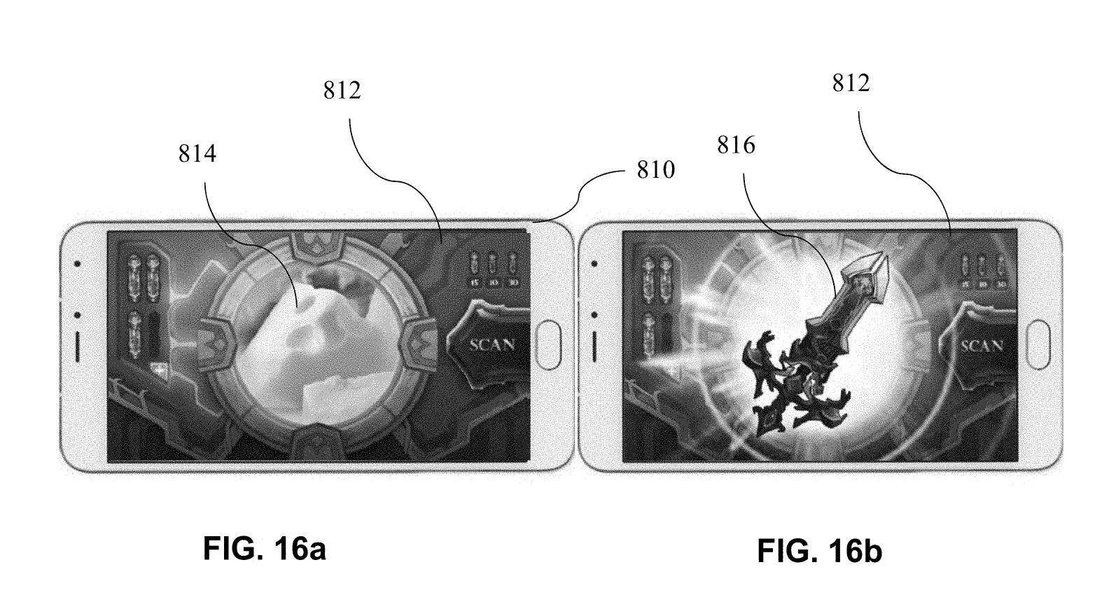

In this example, as shown in FIG. 15, a game player can scan real-life objects with spectrometer to determine one or more game objects (for example, items), and apply the determined game objects with other game objects (for example, player character) within the game. As shown in FIG. 16a and FIG. 16b, the game player can scan a real-life object with a user device 810 and determine a game object. The user device 810 can be, for example, a hand held device which comprises a display 812 and a camera (not shown). The user device 810 can comprises a spectrometer (not shown) which is integrated with the user device. Spectrometer data of the real-life object can be received from the spectrometer, which spectrometer data indicating one or more features of the real-life object. The spectrometer data of the real-life object can comprise spectrum profile of the real-life object which can distinguish the real-life object from others. The features of the real-life object can comprise at least one of a temperature, a geographic location, a category of a material, a type of a material, a chemical composition, a time, an appearance of a material, a color of a material, a taste of a material, a smell of a material, and an observable characteristic associated with a material of the real-life object.

One or more game objects can be determined based on the spectrometer data of the scanned real-life object. In some embodiments, determining a game object can be creating a game object. Alternatively, determining a game object can be selecting a game object from among a plurality of existing game objects. The game object can be an entity within the game, such as a player character, a non-player character and an item. The game object can have one or more attributes. The one or more attributes can indicate a nature or a state of the game object. The one or more attributes of the game object can correspond to the one or more features of the real-life object, such that the game object can carry some parameters/features from the real-life object from which it is created/selected. For instance, an item object (for example, a sword, a gear, an armor or a potion) within a game can have attributes such as value of attack which corresponds to a total fat of the scanned real-life food.

As shown in FIG. 16a, a real-life cheese 814 can be scanned with the spectrometer. The spectrometer data of the scanned cheese can be received from the spectrometer. The one or more features of the cheese can be identified based on a predetermined mapping between the cheese and spectrometer data of the cheese. In some instances, the spectrometer data of the scanned cheese can be transmitted to, processed and analyzed by a remote spectrometer server where spectral data associated with various objects can be stored. The recognized real-life object information, such as one or more features of the cheese, can then be transmitted back to the user device. A game object can then be determined based on the spectrometer data of the scanned cheese, which the game object has one or more attributes corresponding to the one or more features of scanned cheese. For instance, a game object such as “sword” 816 can be created based on features of the scanned cheese 814, as shown in FIG. 16b. Optionally, the “sword” can be selected from a plurality of existing weapons which are preset in the game, based on features of the scanned cheese. Attributes of the “sword” can be displayed on the user device. The attributes of the “sword”, such as a value of attack, can correspond to the one or more features of the scanned cheese such as total fat.

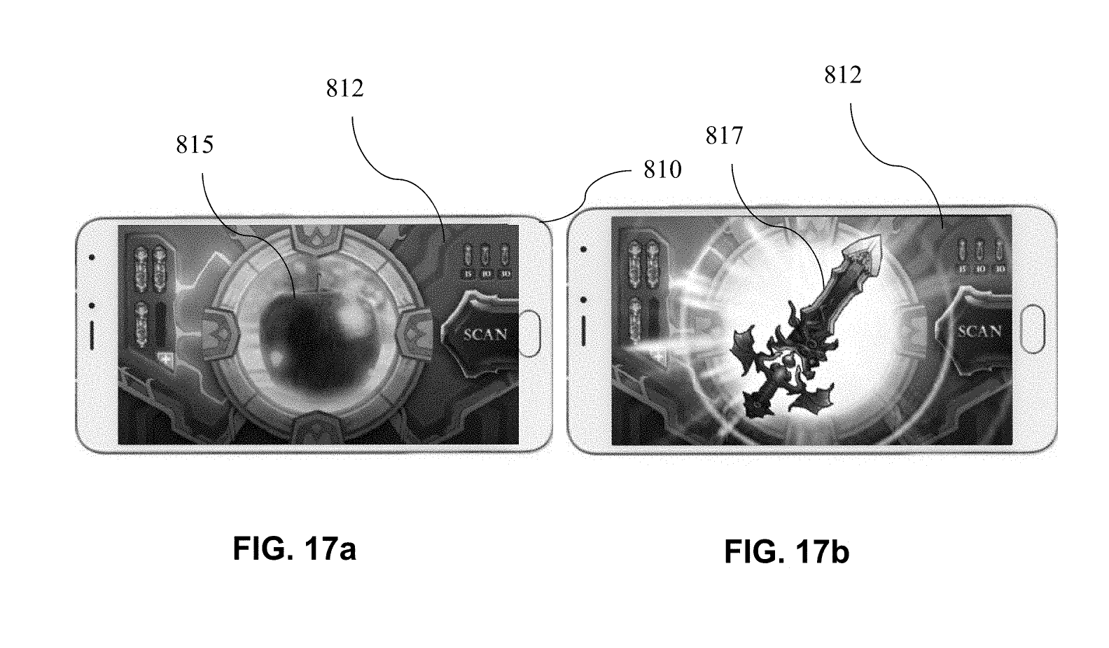

The user can scan more real-life items with the spectrometer, so as to create more game items. As shown in FIG. 17a, a real-life apple 815 can be scanned with the spectrometer. Another game object such as anther “sword” 817 can be determined based on the spectrometer data of the scanned apple, as shown in FIG. 17b. Attributes of the “sword” 817 as shown in FIG. 17b can be different from attributes of the “sword” 816 as shown in FIG. 16b. For example, a value of attack of the “sword” 817 can be different from that of the “sword” 816 because the value of attack of a weapon can correspond to a total fat of the scanned real-life objects.

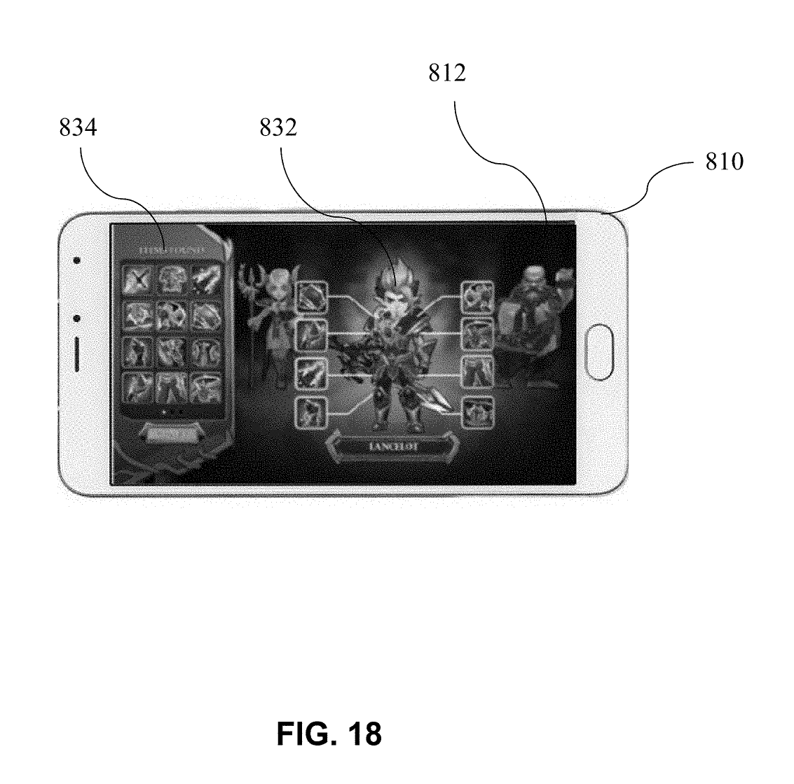

One or more actions can be performed on the game object “sword” 816 or 817 based on the one or more attributes of the game object. In some embodiments, performing one or more actions on the game object can comprise selecting the one or more actions from among a plurality of existing actions. The existing actions can be preset in the game program. For instance, the existing actions can comprise at least applying the game object with another game object within the game. In some embodiments, the game object “sword” can be applied onto another game object such as a player character. As shown in FIG. 18, the game object “sword” can be placed in an armory 834. The game player can select equipment (for example, sword, gear, armor and/or potion) for the player character 832 from the armory. The player character can be created by the game player by scanning real-life objects as discussed hereinabove, or selected from a list of default character provided in the game program. The game items in the armory can be created by the game player by scanning real-life objects as discussed hereinabove. The game items can also comprise default items provided by the game program, or items exchanged with other game player, or items bought with soft currency.

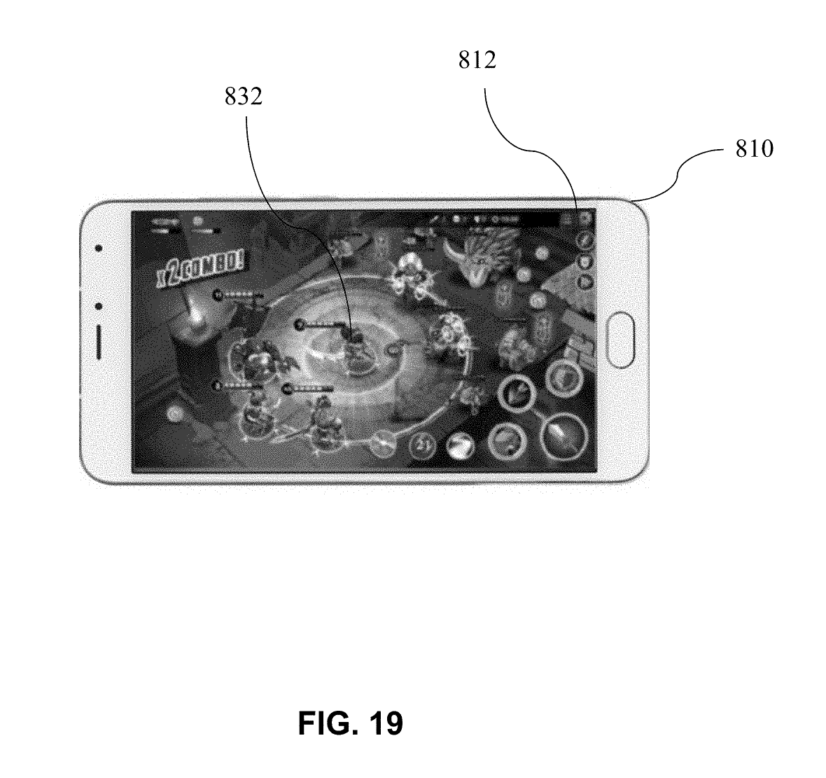

As shown in FIG. 19, the player character can be controlled by the game player in battling. For example, during the game player's turn, the game player can select desired targets, and select a desired attack and then swipe from the center of the character towards the targets.

The exemplary game can be a hectic RPG (role-playing game), full of effects and plenty of shooting. The player's task is to lead his group through the dungeons, activate their special powers and decide when to use various potions. The player can prepare magical weapons, magic infused armor and dark potions, and take his team of heroes into battle. The game can consist of two parts: battle preparations and the battle itself. In the preparation section, the player can equip as well as create gear and weaponry, plenty of magical objects and a variety of special potions. In the battle section, the player can lead his team of heroes through fantastic dungeons infested with many fantastic beasts and “monsters”, as well as other enemies. The player can scan his body stats (or those of his friends) to create a team of unique characters. The player can scan different types of real world items in order to get amazing rewards such as magical armors, legendary weapons, potions and many more. The player can craft legendary gear from pieces he will fuse together using dark magic, as well as enhance these legendary gear items.

The game can use simple tap controls to point the heroes to where they need to go (it can also be possible to add cursor controls). The team can shoot simple attacks autonomously, but the player can control when to dispatch their special attacks, use potions and other, slightly more complex, actions. Simple actions like tap and drag can be used to control the metagame user interface (UI)—inventory management, harvesting the items from real world items, and preparing gear, weapons and potions.

Throughout the game the player will find and win gold coins and several types of energy bars (for example, by killing “monsters”). These can be used to activate the magic device (for example, the spectrometer). The device can use scanned materials for the creation of game items on any successful scan—different types of armor, weapons, and many types of helpful objects. Once the energy runs out, the player can go back to battle and find some more energy. The items the player finds/creates can be easily placed in the inventory or hands/body of each of his hero characters. Construction or enhancement can be applied onto items, allowing more complex mechanics for the spectrometer, such as scanning an element right into a weapon, fusing/filling it with a specific element power (for example, increasing game object's stats and special skills). Each game character can have one special power. All the rest of the special skills and magic powers in the game can come from the gear the player finds/creates (each item can have special effects/skills in addition to the stats to the character using this item). The scans can demand more energy, the higher the level of the scanner will be (but it will also allow the finding/creating better equipment and materials).

The game player can trade gear items with friends. Bonus can be earned when the game player's stats are used in the game. Multiplayer can be added so teams can battle each other in a closed arena. The items and characters can level up constantly, requiring the player to prepare better and better equipment. Soft currency can add more control over the balancing of the game. The scan action with spectrometers can be rewarding and finding a good item can feature a dramatic and exciting moment. The quality of the item found can be based on the quality and nature of the scanned objects. First scan can grant a bonus, thus creating a desire to scan additional items constantly.

The lead game character and/or other game characters can be created using spectrometers on body of real persons to create a more personal experience. Scanning a person ca impact the creation of the game character statistics and also the look of the game character (such as skin tone, vitals, male/female), as well as other characteristics such as the game character sounds. The spectrometer scan frequency (for example, the amount of times the player has to use the spectrometer scanning) can be balanced, for example allowing the player to find basic weapons/armor in the game and use the spectrometer for the more special equipment.

In the exemplary game “Battle Craft”, a method performed by a user device of running a game based on spectrometer data can be implemented. The spectrometer data of a real-life object (for example, a cheese or an apple) can be received from a spectrometer. The spectrometer data can indicate one or more features of the real-life object (for example, a total fat). A game object (for example, a “sword”) can be determined based on the spectrometer data. The game object can have one or more attributes (for example, a value of attack) corresponding to the one or more features of the real-life object. One or more actions can be performed on the game object based on the one or more attributes of the game object. For example, the game object can be applied with other game objects within the game.

In the exemplary game “Battle Craft”, a method performed by a game-development device for developing a game based on spectrometer data can be implemented. A first mapping between a real-life object and spectrometer data of the real-life object can be acquired at the game-development device such as a game server. The spectrometer data can indicate one or more features of the real-life object (for example, a total fat of the cheese). A second mapping between the spectrometer data and one or more game attributes of a game object can be built by the one or more processors of the game-development device. The game object can have one or more attributes (for example, a value of attack of the sword) corresponding to the one or more of features of the real-life object. A plurality of rules that govern a processing of the game object can be created based on the one or more attributes of the game object. For example, the rules specifying how the game object can be applied with other game objects can be determined at the game server. Game information including the plurality of rules can be sent to the user device where interaction between the game player and the game can be implemented via a graphical user interface.

### Example 4 “The Alchemist”

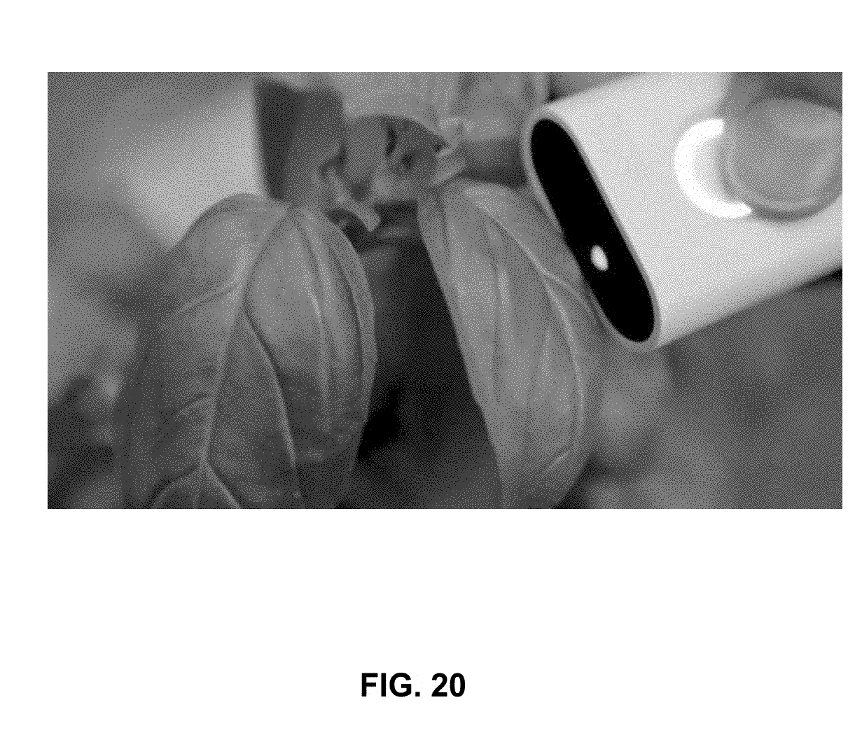

FIGS. 20-22 show another example of a game, which implements a method performed by a user device of running a game based on spectrometer data and a method performed by a game-development device for developing a game based on spectrometer data, in accordance with some embodiments of the present disclosure. The exemplary example can be explained with reference to a game named “The Alchemist”.

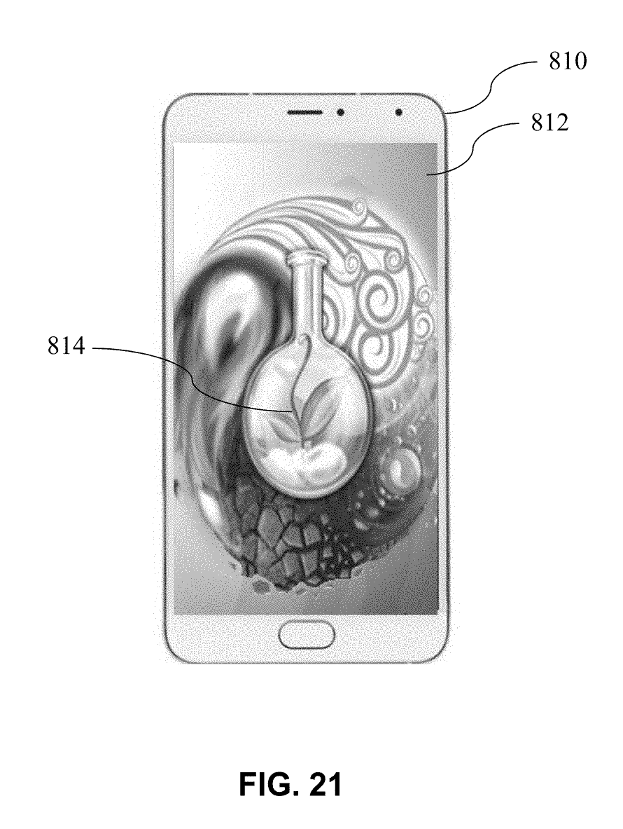

In this example, a game player can scan real-life objects with spectrometer to determine one or more game objects (for example, game items), and combine the determined game objects with other game objects (for example, other game items) to create a new game object (for example, a new game item). As shown in FIGS. 20 and 21, the game player can scan a real-life object with a user device 810 and determine a game object. The user device 810 can be for example a hand held device which comprises a display 812 and a camera (not shown). The user device 810 can comprises a spectrometer (not shown) which is integrated with the user device. Spectrometer data of the real-life object can be received from the spectrometer, which spectrometer data indicating one or more features of the real-life object. The spectrometer data of the real-life object can comprise spectrum profile of the real-life object which can distinguish the real-life object from others.

One or more game objects can be determined based on the spectrometer data of the scanned real-life object. In some embodiments, determining a game object can be creating a game object. Alternatively, determining a game object can be selecting a game object from among a plurality of existing game objects. The game object can be an entity within the game, such as a player character, a non-player character and an item. The game object can have one or more attributes. The one or more attributes can indicate a nature or a state of the game object. The one or more attributes of the game object can correspond to the one or more features of the real-life object, such that the game object can carry some parameters/features from the real-life object from which it is created/selected. For instance, a game object (for example, a potion raw material) within the game can have attributes such as composition which corresponds to a chemical composition of the scanned real-life plant leaf.

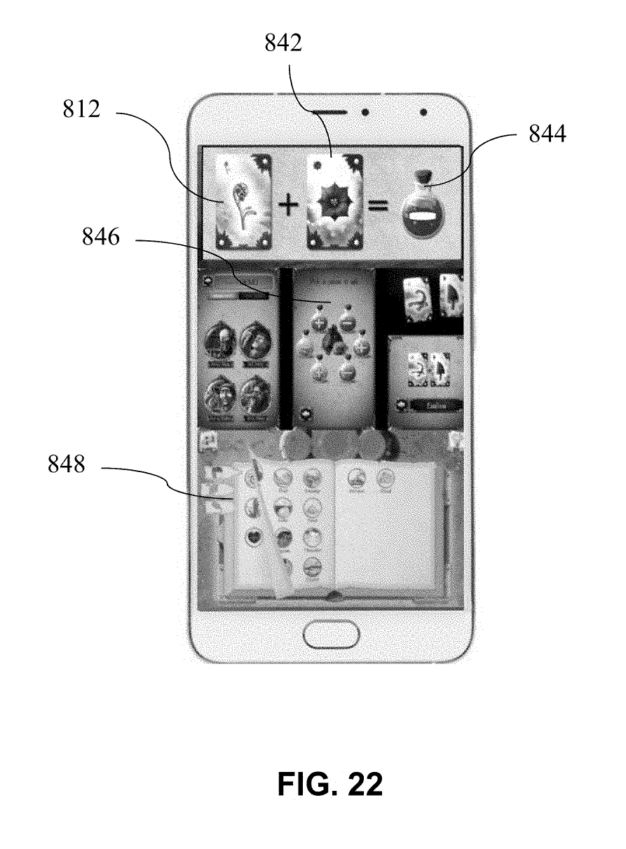

As shown in FIG. 21, a real-life plant leaf 814 can be scanned with the spectrometer. The spectrometer data of the scanned plant leaf can be received from the spectrometer. The one or more features of the plant leaf can be identified based on a predetermined mapping between the plant leaf and spectrometer data of the cheese. In some instances, the spectrometer data of the scanned plant leaf can be transmitted to, processed and analyzed by a remote spectrometer server where spectral data associated with various objects can be stored. The recognized real-life object information, such as one or more features of the plant leaf, can then be transmitted back to the user device. A game object can then be determined based on the spectrometer data of the scanned plant leaf, which the game object has one or more attributes corresponding to the one or more features of scanned plant leaf. For instance, a game object such as “potion raw material No. 1” can be created based on features (for example, the chemical composition) of the scanned plant leaf, as shown in FIG. 22. The user can scan more real-life items with the spectrometer, so as to create more game objects such as “potion raw material No. 2”, “potion raw material No. 3”, and so on.

One or more actions can be performed on the game object based on the one or more attributes of the game object. Performing one or more actions on the game object can comprise selecting the one or more actions from among a plurality of existing actions. The existing actions can be preset in the game program. For instance, the existing actions can comprise at least one of selecting one or more game objects, displaying attributes of the game object, or combining two or more game objects to create a new game object. In some embodiments, the game object “potion raw material No. 1” can be selected and combined with one or more other game objects to create a new game object. As shown in FIG. 22, the game object “potion raw material No. 1” 812 can be selected and combined with another game object “potion raw material No. 2” 842 to create a new game object 844 such as a magic potion. The created potion can be placed in a potion kit 846 within the game. The potions owned by the game player can be used for exchange with other game players, or for selling to gain soft currency. Hints 848 can be provided to the game player on how to create various potions. The game player can select the game object (for example, potion raw materials) he already has or can scan more real-life objects so as to create the desired potions.

The exemplary game can be an exploration game combined with resource management. The player can take on a role of powerful mystical characters like the Druid, the Shaman or the Wizard. The player can brew potions to grow his own magical power.

The gameplay revolves around looking for ingredients each season—a cycle that happens once every few hours. These ingredients can be found within various real-life objects (for example, frog legs, spider webs, dragon eggs, etc.). Potions are a way to combine ingredients with magic to make other more complex potions, sell them to gain currency and other resources, or equip heroes with them so they can bring them some of the reward. Each game character (for example, Druid, Shaman or the Wizard) has variable powers and slightly different stats and potions he can make or items he can find, which modifies the gameplay and allows more replay value. After all ingredients have been harvested, players use magic to prepare the Potions.

In the exemplary game “The Alchemist”, the player needs to find, collect and brew different ingredients into special potions. The player will get hints about what to find in order to craft each one. Each time the player manages to craft a potion, he can gain experience point to level up, and can unlock harder potions to craft. The player can scan his environment to find different ingredients with spectrometers, for example sugar and water from fruits, fat from meat and so on. Many ingredients may not be food related—the player may need to think out of the box in order to find them at the least expected places.

In the game, a medieval version of a spectrometer can sit on a table. Pressing it will start the real life exploration scanning sequence. The player's screen can change into an animated screen, possibly with an enigmatic text telling the player to go and scan objects—“find what lies within . . . ”. When scanning is done, a simple screen showing a list of raw materials extracted can be displayed to the user. Each item on the list can include the name, visual icon and two other buttons: store, and discard. This screen may show up to 5 or so materials. There can also be two buttons at the bottom of the screen—“store all” and “discard all” for faster navigation. Storing can put the raw material in the storage screen (ready to be crafted).

Preparing the potions can be easy. The player can have a few potion layouts. The basic one can be, for example, a 3 slots layout. The player is able to place any 3 ingredients in there. If these ingredients are right (can create a potion), a button can highlight saying “create” and any additional information can pop, like tips about making that potion perfect or better. During the game, the player can receive hints in the form of pages from ancient alchemy books with information or partial information on how to brew new kinds of potions.

In an illustrative campaign mission example, each time the player opens the door, a guest can stand there asking for a potion. The screen can consist of a cool character standing in the door and a big text box under it represents what it says. For example a mighty warrior may stand at the player door saying “Greetings to you, I am X'ar the warrior of the great eastern plans. I am on my way to the Moon Dungeon to defeat the Night King, I may require your assistance for I have to prepare myself for the coming battles. Therefore, good Alchemist, I shall require 2 health potions, rage potion, and a resurrection vile in case things go bad. For this I thank you, great Alchemist”. The game player can have a big TRADE button that opens the storage shelf screen, where the player may choose a potion. If the player chooses a correct potion, the highlighted text in the text box can change to green, showing the character now has the potion. The player may need to make sure all requested potions are green. When the player finishes giving all correct potions, he can finish the trade and the text box can change to a thank you text, for example “I thank you fine Alchemist, please take these as my gratitude”. A simple reward screen can then show and can display the rewards the player got. These could be experience point, gold, other raw materials, empty jars, and other potions sometimes.

Next to the TRADE button there can be a “No Thanks” button and a “Wait a bit” button. Using the “No Thanks” button can discard the guest, but there might be consequences (lose experience point, gold, etc.). The “Wait a bit” button can allow the player to go back and work in his lab—the player can leave the character and return to it at any point, when the player is ready. When the character leaves, another one can take his place. It can be another warrior asking for a damage potion, a neighbor witch asking for some sweet essence, a sick villager asking you to save his son, and so on.

In the exemplary game “The Alchemist”, a method performed by a user device of running a game based on spectrometer data can be implemented. The spectrometer data of a real-life object (for example, a plant leaf) can be received from a spectrometer. The spectrometer data can indicate one or more features of the real-life object (for example, a chemical composition of the plant leaf). A game object (for example, “potion raw material”) can be determined based on the spectrometer data. The game object can have one or more attributes (for example, a composition or a medical effect of the “potion raw material”) corresponding to the one or more features of the real-life object. One or more actions can be performed on the game object based on the one or more attributes of the game object. For example, the game object can be combined with other one or more game objects to create a new game object.

In the exemplary game “The Alchemist”, a method performed by a game-development device for developing a game based on spectrometer data can be implemented. A first mapping between a real-life object and spectrometer data of the real-life object can be acquired at the game-development device such as a game server. The spectrometer data can indicate one or more features of the real-life object (for example, a chemical composition of the plant leaf). A second mapping between the spectrometer data and one or more game attributes of a game object can be built by the one or more processors of the game-development device. The game object can have one or more attributes (for example, a composition or a medical effect of the “potion raw material”) corresponding to the one or more of features of the real-life object. A plurality of rules that govern a processing of the game object can be created based on the one or more attributes of the game object. For example, the rules specifying how the game object can be combined with other one or more game objects to create a new game object can be determined at the game server. Game information including the plurality of rules can be sent to the user device where interaction between the game player and the game can be implemented via a graphical user interface.

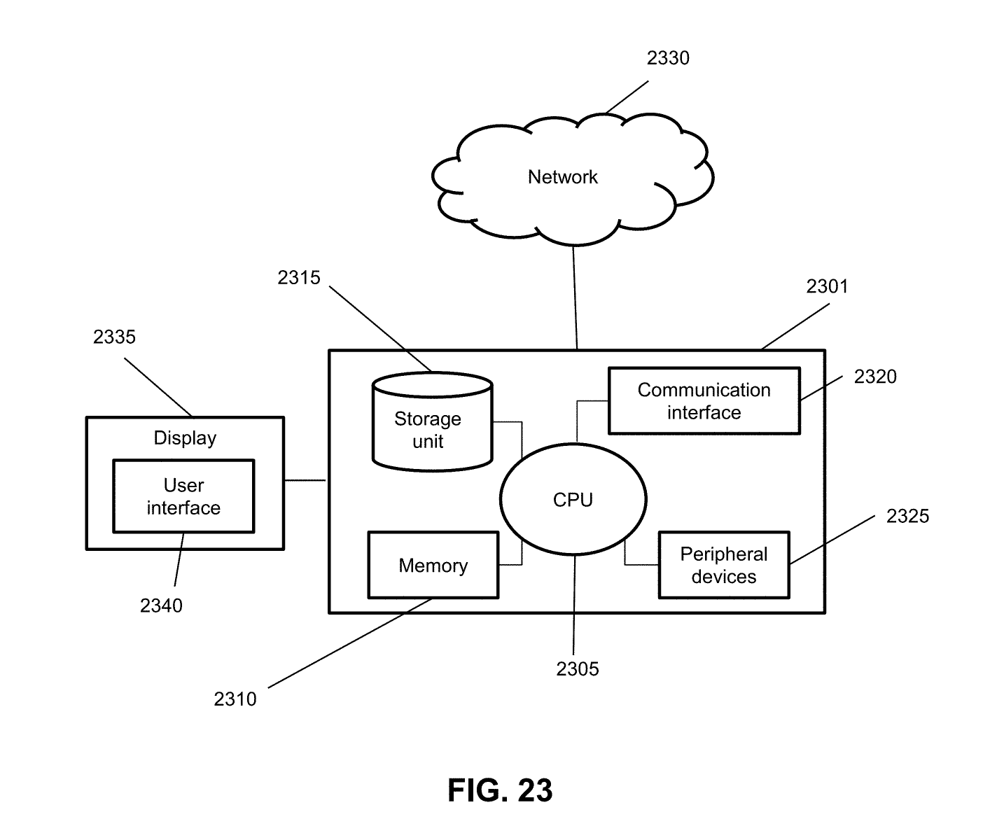

The present disclosure provides computer control systems that are programmed to implement methods of the disclosure. FIG. 23 shows a computer system 2301 suitable for incorporation with the methods and apparatus in accordance with some embodiments of the present disclosure. The computer system 2301 can process various aspects of information of the present disclosure, such as, for example, questions and answers, responses, statistical analyses. The computer system 2301 can be an electronic device of a user or a computer system that is remotely located with respect to the electronic device. The electronic device can be a mobile electronic device.

The computer system 2301 includes a central processing unit (CPU, also “processor” and “computer processor” herein) 2305, which can be a single core or multi core processor, or a plurality of processors for parallel processing. The computer system 2301 also includes memory or memory location 2310 (e.g., random-access memory, read-only memory, flash memory), electronic storage unit 2315 (e.g., hard disk), communication interface 2320 (e.g., network adapter) for communicating with one or more other systems, and peripheral devices 2325, such as cache, other memory, data storage and/or electronic display adapters. The memory 2310, storage unit 2315, interface 2320 and peripheral devices 2325 are in communication with the CPU 2305 through a communication bus (solid lines), such as a motherboard. The storage unit 2315 can be a data storage unit (or data repository) for storing data. The computer system 2301 can be operatively coupled to a computer network (“network”) 2330 with the aid of the communication interface 2320. The network 2330 can be the Internet, an internet and/or extranet, or an intranet and/or extranet that is in communication with the Internet. The network 2330 in some cases is a telecommunication and/or data network. The network 2330 can include one or more computer servers, which can enable distributed computing, such as cloud computing. The network 2330, in some cases with the aid of the computer system 2301, can implement a peer-to-peer network, which may enable devices coupled to the computer system 2301 to behave as a client or a server.

The CPU 2305 can execute a sequence of machine-readable instructions, which can be embodied in a program or software. The instructions may be stored in a memory location, such as the memory 2310. The instructions can be directed to the CPU 2305, which can subsequently program or otherwise configure the CPU 2305 to implement methods of the present disclosure. Examples of operations performed by the CPU 2305 can include fetch, decode, execute, and writeback.

The CPU 2305 can be part of a circuit, such as an integrated circuit. One or more other components of the system 2301 can be included in the circuit. In some cases, the circuit is an application specific integrated circuit (ASIC).

The storage unit 2315 can store files, such as drivers, libraries and saved programs. The storage unit 2315 can store user data, e.g., user preferences and user programs. The computer system 2301 in some cases can include one or more additional data storage units that are external to the computer system 2301, such as located on a remote server that is in communication with the computer system 2301 through an intranet or the Internet.

The computer system 2301 can communicate with one or more remote computer systems through the network 2330. For instance, the computer system 2301 can communicate with a remote computer system of a user (e.g., a parent). Examples of remote computer systems and mobile communication devices include personal computers (e.g., portable PC), slate or tablet PC's (e.g., Apple® iPad, Samsung® Galaxy Tab), telephones, Smart phones (e.g., Apple® iPhone, Android-enabled device, Blackberry®), personal digital assistants, wearable medical devices (e.g., Fitbits), or medical device monitors (e.g., seizure monitors). The user can access the computer system 2301 with the network 2330.

Methods as described herein can be implemented by way of machine (e.g., computer processor) executable code stored on an electronic storage location of the computer system 2301, such as, for example, on the memory 2310 or electronic storage unit 2315. The machine executable or machine readable code can be provided in the form of software. During use, the code can be executed by the processor 2305. In some cases, the code can be retrieved from the storage unit 2315 and stored on the memory 2310 for ready access by the processor 2305. In some situations, the electronic storage unit 2315 can be precluded, and machine-executable instructions are stored on memory 2310.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2301 can include or be in communication with an electronic display 2335 that comprises a user interface (UI) 2340 for providing, for example, questions and answers, analysis results, recommendations. Examples of UI's include, without limitation, a graphical user interface (GUI) and web-based user interface.

Methods and systems of the present disclosure can be implemented by way of one or more algorithms and with instructions provided with one or more processors as disclosed herein. An algorithm can be implemented by way of software upon execution by the central processing unit 2305. The algorithm can be, for example, random forest, graphical models, support vector machine or other.

Although the above steps show a method of a system in accordance with an example, a person of ordinary skill in the art will recognize many variations based on the teaching described herein. The steps may be completed in a different order. Steps may be added or deleted. Some of the steps may comprise sub-steps. Many of the steps may be repeated as often as if beneficial to the platform.

Each of the examples as described herein can be combined with one or more other examples. Further, one or more components of one or more examples can be combined with other examples.

Although the detailed description contains many specifics, these should not be construed as limiting the scope of the disclosure but merely as illustrating different examples and aspects of the present disclosure. It should be appreciated that the scope of the disclosure includes other embodiments not discussed in detail above. Various other modifications, changes and variations which will be apparent to those skilled in the art may be made in the arrangement, operation and details of the method and apparatus of the present disclosure provided herein without departing from the “spirit” and scope of the invention as described herein.

While preferred embodiments of the present disclosure have been shown and described herein, it will be obvious to those skilled in the art that such embodiments are provided by way of example only. Numerous variations, changes, and substitutions will be apparent to those skilled in the art without departing from the scope of the present disclosure. It should be understood that various alternatives to the embodiments of the present disclosure described herein may be employed without departing from the scope of the present invention. Therefore, the scope of the present invention shall be defined solely by the scope of the appended claims and the equivalents thereof.

1. A method performed by a user device of running a game based on spectrometer data, the method comprising:
receiving, from a spectrometer, the spectrometer data of a real-life object from the spectrometer, the spectrometer data indicating one or more features of the real-life object;
determining, by one or more processors, a game object based on the spectrometer data, wherein the game object has one or more attributes corresponding to the one or more features of the real-life object; and
performing one or more actions on the game object based on the one or more attributes of the game object.

2. The method of claim 1, wherein the spectrometer data comprises a spectrum profile.

3. The method of claim 1, wherein the real-life object comprises an organic object.

4. The method of claim 3, wherein the organic object is food.

5. The method of claim 3, wherein the organic object is a plant.

6. The method of claim 1, wherein the real-life object comprises an inorganic object.

7. The method of claim 1, wherein the real-life object comprises a human being.

8. The method of claim 7, wherein the human being is a game player.

9. The method of claim 1, wherein the one or more features of the real-life object comprise a composition of the real-life object.

10. The method of claim 1, wherein the one or more features of the real-life object comprise a category of the real-life object.

11. The method of claim 1, wherein determining the game object comprises identifying the real-life object based on the spectrometer data.

12. The method of claim 11, wherein identifying the real-life object is based on a predetermined mapping between the real-life object and the spectrometer data.

13. The method of claim 1, wherein determining the game object comprises creating the game object based on the spectrometer data.

14. The method of claim 1, wherein determining the game object comprises selecting the game object from existing game objects.

15. The method of claim 1, wherein determining the game object comprises sending the spectrometer data to a spectrometer server over a communication network, and receiving information regarding the game object from the spectrometer server, the spectrometer server comprising a database storing and updating spectrometer data associated with real-life objects.

16. The method of claim 1, wherein performing one or more actions on the game object comprises selecting the one or more actions from among a plurality of existing actions.

17. The method of claim 1, wherein performing one or more actions on the game object comprises updating the one or more attributes of the game object.

18. The method of claim 1, wherein performing one or more actions on the game object comprises displaying the one or more attributes of the game object.

19. The method of claim 1, wherein performing one or more actions on the game object comprises updating a cumulative score.

20. The method of claim 1, wherein performing one or more actions on the game object comprises causing at least one interaction between the game object and one or more other game objects based on the one or more attributes.

21. The method of claim 20, further comprising updating a score based on the at least one interaction.

22. The method of claim 21, wherein the score is updated by comparing the one or more attributes of the game object with corresponding one or more attributes of the one or more other game objects.

23.-90. (canceled)
